(19) United States
(12) Patent Application Publication
(10) Pub. No.: US 2026/0162017 A1
(43) Pub. Date: Jun. 11, 2026

(54) METHOD, APPARATUS, AND SYSTEM FOR PREDICTING CONTINUOUS SEQUENCE

(71) Applicant: LG MANAGEMENT DEVELOPMENT INSTITUTE CO., LTD., Seoul (KR)

(72) Inventors: Jae Hoon LEE, Seoul (KR); Sung Woo Park, Seoul (KR)

(21) Appl. No.: 19/409,644

(22) Filed: Dec. 4, 2025

Related U.S. Application Data
(63) Continuation of application No. PCT/KR2025/013564, filed on Sep. 3, 2025.

(30) Foreign Application Priority Data
Dec. 9, 2024 (KR) 10-2024-0181669
Apr. 23, 2025 (KR) 10-2025-0053205

(51) Int. Cl. G06N 20/00

(52) U.S. Cl. CPC G06N 20/00

(57) ABSTRACT

An embodiment of the invention is directed to providing a system including at least one processor, an artificial intelligence prediction model, and at least one memory storing one or more instructions that, when executed by the at least one processor, cause the at least one processor to perform operations. The operations may include generating a plurality of observation data by sampling past data with an arbitrary time distribution, generating a propagation signal associated with each of the plurality of observation data based on mean-field theory, determining a predicted value by aggregating calculation results of the propagation signals associated with the plurality of observation data, determining a loss value based on a difference between the predicted value and a true value, and training the artificial intelligence prediction model until the loss value becomes less than or equal to a predetermined value.

### CROSS REFERENCE TO RELATED APPLICATIONS

This application is a Bypass Continuation of International Patent Application No. PCT/KR2025/013564, filed on Sep. 3, 2025, which claims priority from and the benefit of Korean Patent Application No. 10-2024-0181669, filed on Dec. 9, 2024 and Korean Patent Application No. 10-2025-0053205, filed on Apr. 23, 2025, each of which is hereby incorporated by reference for all purposes as if fully set forth herein.

### BACKGROUND

### Field

Embodiments of the invention relate generally to a continuous sequence prediction method, apparatus, and system, and more particularly, to a system, an apparatus, and a method for predicting a future by using data sequentially recorded over time based on mean-field theory.

### Discussion of the Background

Time-series data refers to data sequentially recorded over time. A problem of predicting a future by analyzing observed time-series data is a time-series forecasting problem. However, despite numerous recent studies, there is no predictor applicable and extendable in terms of both temporal irregularity and spatio-temporal causality.

The above information disclosed in this Background section is only for understanding of the background of the inventive concepts, and, therefore, it may contain information that does not constitute prior art.

### SUMMARY

The invention is directed to providing a continuous sequence prediction method, apparatus, and system applicable even to irregular time-series data and to exponentially increasing observation data caused by fine sampling.

Additional features of the inventive concepts will be set forth in the description which follows, and in part will be apparent from the description, or may be learned by practice of the inventive concepts.

An embodiment of the invention may provide a continuous sequence prediction method, apparatus, and system applicable even to irregular time-series data and exponentially increasing observation data caused by fine sampling.

A system according to an embodiment of the invention may include at least one processor, an artificial intelligence prediction model, and, at least one memory collectively storing instructions that, when executed by the at least one processor, cause the system to perform operations, wherein the operations may include an operation of sampling past data with an arbitrary time distribution to generate a plurality of observation data, an operation of calculating a propagation signal of each of the plurality of observation data based on mean-field theory, an operation of aggregating calculation results of the propagation signals for the plurality of observation data to determine a predicted value, an operation of determining a loss value based on a difference between the predicted value and a true value, and an operation of training the artificial intelligence prediction model until the loss value becomes less than or equal to a predetermined value.

In an embodiment, the operation of calculating the propagation signal of each of the plurality of observation data may include an operation of calculating the propagation signal of each of the plurality of observation data by calculating a partial differential equation using gradient descent. Here, the partial differential equation may include a forward-backward partial differential equation (FBPDE).

In an embodiment, the operation of calculating the propagation signal of each of the plurality of observation data may include an operation of generating a forward propagation signal, and an operation of generating a backward propagation signal based on the forward propagation signal, wherein the operations may further include an operation of updating a control profile based on the backward propagation signal.

In an embodiment, the operation of calculating the propagation signal of each of the plurality of observation data may include an operation of generating a forward propagation signal and a backward propagation signal of each of the plurality of observation data using a neural graphon that is a symmetric integrable function.

In an embodiment, the neural graphon may include at least one of an exponential graphon and a cosinusoidal graphon.

In an embodiment, the artificial intelligence prediction model, after being trained until the loss value becomes less than or equal to a predetermined value, may be used as a predictor for predicting future information.

In an embodiment, the operations may include an operation of determining an aggregation distribution using an attention mechanism.

A computer-implemented method according to an embodiment of the invention, when executed on data processing hardware, causing the data processing hardware to perform operations, the operations may include an operation of sampling past data with an arbitrary time distribution to generate a plurality of observation data, an operation of calculating a propagation signal of each of the plurality of observation data based on mean-field theory by at least one processor, an operation of aggregating a propagation signal calculation result for the plurality of observation data to determine a predicted value, an operation of determining a loss value based on a difference between the predicted value and a true value, and an operation of training an artificial intelligence prediction model until the loss value becomes less than or equal to a predetermined value.

An embodiment of the invention may include a program stored in a recording medium to execute the method according to an embodiment of the invention on a computer.

An embodiment of the invention may include a computer-readable recording medium in which a program for executing the method according to an embodiment of the invention on a computer is recorded.

An embodiment of the invention may include a computer-readable recording medium in which a database used in an embodiment of the invention is recorded.

According to an embodiment of the invention, it is possible to effectively capture probabilistic spatio-temporal dynamics of countless agent continua based on prediction from time-series analysis.

In addition, according to an embodiment of the invention, a mean-field continuous sequence predictor capable of efficiently generating a continuous sequence having complexity of an order approaching infinity can be provided.

In addition, according to an embodiment of the invention, by using a graphon, a complex inductive bias in time-series data can be captured.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1A is a diagram illustrating a method of sampling past information with an arbitrary time distribution according to an embodiment of the invention.

FIG. 1B is a diagram illustrating a method of generating a future prediction through propagation according to an embodiment of the invention.

FIG. 2A is a diagram illustrating an example of an exponential graphon according to an embodiment of the invention.

FIG. 2B is a diagram illustrating an example of a cosinusoidal graphon according to an embodiment of the invention.

FIG. 3 is a flowchart of a prediction method using mean-field theory according to an embodiment of the invention.

FIG. 4 is a diagram illustrating a gradient system of a mean-field predictor related to updated parameters of neural agents at an m-th iteration step according to an embodiment of the invention.

FIG. 5 is a block diagram of a computing system for performing a method of predicting future data according to an embodiment of the invention.

FIG. 6 is a block diagram of a computing device, which is one of the components of the computing system for performing the method of predicting future data according to an embodiment of the invention.

FIG. 7 is another block diagram showing another aspect of a computing device, which is one of the components of the computing system for performing the method of predicting future data according to an embodiment of the invention.

FIG. 8 is a flowchart of a method of predicting a forecast of a target through a machine learning model according to an embodiment of the invention.

FIG. 9 is a diagram illustrating a meta-architecture for performing the method of predicting a forecast of a target according to an embodiment of the invention.

FIG. 10 is a diagram illustrating a process of executing a target prediction task and determining causal information with target prediction variables according to an embodiment of the invention.

FIG. 11 is a diagram illustrating a process of performing data preparation based on causal information according to an embodiment of the invention.

FIG. 12 is a diagram illustrating a process of converting unstructured data into quantitative data according to an embodiment of the invention.

FIG. 13 is a diagram illustrating a process of integrating structured data and quantitative data to calculate a forecast of a target according to an embodiment of the invention.

FIG. 14 is a diagram illustrating a process of deriving grounds of a target forecast and a process of predicting an additional target forecast according to a user simulation according to an embodiment of the invention.

FIG. 15 is an exemplary diagram of a chart for a predicted target forecast according to an embodiment of the invention.

FIG. 16 is an example of a causal graph presented as ground data of the predicted target forecast according to an embodiment of the invention.

FIG. 17 is another example of the causal graph presented as ground data of the predicted target forecast according to an embodiment of the invention.

FIG. 18 is a flowchart of a method of performing a what-if simulation according to an embodiment of the invention.

FIG. 19 is a graph related to a general result and a what-if result according to an embodiment of the invention.

FIG. 20A is a diagram illustrating a time-series forecasting method of a transformer model in which one observation corresponds to one token according to an embodiment of the invention.

FIG. 20B is a diagram illustrating a time-series forecasting method of a segment-based transformer model according to an embodiment of the invention.

FIG. 21 is a schematic diagram of an efficient segment-based sparse transformer (ESSformer) block according to an embodiment of the invention.

FIG. 22 is a flowchart illustrating a prediction data generation method according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In order to clarify the technical spirit of the invention, embodiments of the invention will be described in detail with reference to the accompanying drawings. In describing the invention, when it is determined that the detailed description of a related known function or component may unnecessarily obscure the gist of the invention, the detailed description thereof will be omitted. In the drawings, components having substantially the same function or configuration are given the same reference numerals and symbols as possible even when they are shown in different drawings. For convenience of explanation, an apparatus and method will be described together when necessary. Each operation of the invention does not necessarily need to be performed in the order described, and may be performed in parallel, selectively, or individually.

Terms used in the embodiments of the invention were selected as general terms widely used at present as possible while considering functions of the invention, but these terms may vary depending on the intention of those skilled in the art, legal precedents, the emergence of new technologies, or the like. In addition, in specific cases, there are terms arbitrarily selected by the applicant, and in this case, the meanings thereof will be described in detail in the description of the corresponding embodiment. Therefore, terms used in the present specification should be defined based on the meanings of the terms and the overall contents of the invention rather than just the names of the terms.

Throughout the invention, singular expressions may include plural expressions unless the context explicitly states otherwise. It should be understood that terms such as “comprise” or “have” are intended to specify the presence of a feature, number, step, operation, component, part, or a combination thereof, but do not preemptively preclude the possibility of the presence or addition of one or more other features, numbers, steps, operations, components, parts, or combinations thereof. That is, throughout the invention, when a certain portion is described as “including,” a certain component, it means further including another component rather than precluding another component unless especially stated otherwise.

Expressions such as “at least one” modify the entire list of components, and do not individually modify components of the list. For example, “at least one of A, B, and C” or “at least one of A, B, or C” refers to only A, only B, only C, both A and B, both B and C, both A and C, all of A, B, and C, or a combination thereof.

In addition, terms such as “ . . . unit,” “ . . . module”, etc. described in the invention is mean a unit that process at least one function or operation, which may be implemented as hardware or software, or a combination of hardware and software.

Throughout the invention, when a certain portion is described as being “connected” to another portion, it includes not only a case where the certain portion is “directly connected” to another portion, but also a case where the certain portion is “electrically connected” to another portion with another element interposed therebetween. In addition, when a certain portion is described as “including” a certain component, it means further including another component rather than precluding another component unless specifically stated otherwise.

The expression “configured to (or set to)” as used throughout the invention may, depending on the contexts, be used interchangeably with, for example, “suitable for,” “having the capacity to,” “designed to,” “adapted to,” “made to,” or “capable of.” The term “configured to (or set to)” does not necessarily mean only “specifically designed to” in hardware. Instead, in certain contexts, the expression “a system configured to” may mean that the system is “capable of” in conjunction with other devices or parts. For example, the phrase “a processor configured to (or set to) perform A, B, and C” may mean a dedicated processor (e.g., an embedded processor) for performing corresponding operations, or a generic-purpose processor (e.g., a CPU or application processor) that can perform corresponding operations by executing one or more software programs stored in memory.

Throughout the invention, the notation [N:M] denotes a set of integers from N to M, where N is included and M is not included. That is, [N:M] may mean {N, N+1, . . . , M−1}.

Modeling spatio-temporal processes can improve the ability to predict the behavior of a complex system and provide deep insights. Recently, a neural differential equation model has been proposed to model spatio-temporal processes, but even the neural differential equation model does not address how to handle a large amount of computation when an infinite (or quasi-infinite) number of observations must be processed by finely subdividing time intervals. Therefore, an embodiment of the invention is to directly model to predict future data in continuous intervals having infinite or quasi-infinite complexity, and is directed to developing a prediction decision-making framework in infinite or quasi-infinite dimensions by using a mean-field game and to providing a generalization of a differential equation model.

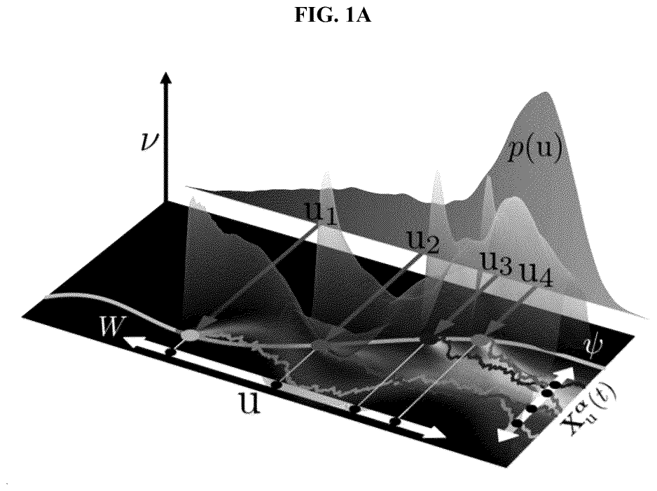

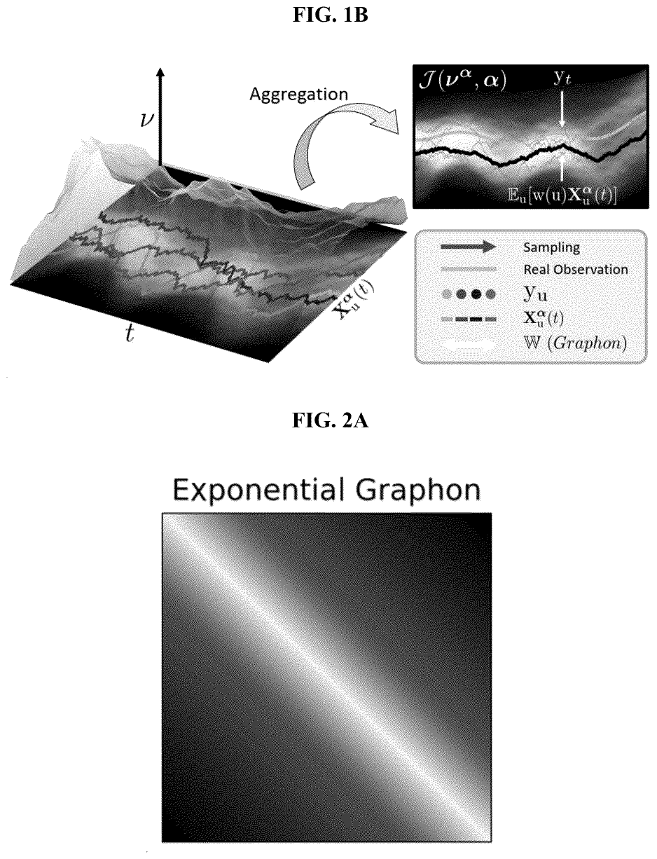

FIG. 1A is a diagram illustrating a method of sampling past information with an arbitrary time distribution according to an embodiment of the invention.

Referring to FIG. 1A, a processor may generate a plurality of observation data by sampling past data with an arbitrary time distribution. Throughout the invention, observation data may be referred to as an observation. In the example shown in FIG. 1A, the past data may be sampled at times t₁, t₂, t₃, and t₄. In this case, time intervals between t₁, t₂, t₃, and t₄ do not need to be uniform. An embodiment of the invention is directed to providing a system capable of enabling accurate prediction even for irregular observations in which time intervals of sampling (e.g., intervals between t₁, t₂, t₃, and t₄) are not uniform.

In an embodiment, the plurality of observation data may be generated based on the past data sampled with an arbitrary time distribution. A label of past observation data may be represented as u. For example, an infinite label sequence u_{∞}={uₙ˜p(u); n≤N→∞} may be conditionally set on a past observation interval.

For example, an observation data label u₁ at time t₁, an observation data label u₂ at time t₂, an observation data label u₃ at time t₃, and an observation data label u₄ at time t₄ may be generated. In an embodiment, p(u) is a label distribution, which provides a continuous representation of the past observation data.

In an embodiment, v is a probability measurement, which may provide a continuous representation of the past observation data by concisely expressing a dynamic law of a system. Specifically, v may be defined as v:={vᵥ(t)}(v,t)∈O×T. Here, vᵥ(t) is a measurement for a label v at time t, and O×T is a set representation of a label and time.

In an embodiment,

$${X}_{u}^{a} ( t )$$

denotes a state variable at label u and time t, and may represent a mean-field predictor.

$${X}_{u}^{a} ( t )$$

may include continuous information up to time t after being initialized at a past observation data yu.

In an embodiment, a neural graphon is represented as W and may be used to model continuous time-series data. [symbol] _{α} is defined as a measure-valued function for v, and may be represented as [symbol] Wαv, ψ [symbol] in combination with ψ. Each spatio-temporal dynamic may be interconnected through the neural graphon [symbol] _{α} that utilizes inductive bias tailored to sequential data.

In an embodiment, a Euler-Maruyama sampling method for graphon interaction particles may be used to generate a set of the mean-field predictors at each time stamp. In an embodiment, the following [Algorithm 1] is an algorithm for sampling the mean-field predictor, in which α*=α(⋅; θ*) is assumed to be optimal from the perspective of mean-field equilibrium in a gradient system operating with FBSDE (Forward-Backward Stochastic Differential Equations).

Algorithm 1
Algorithm 1 Sampling Mean-field Continuous Sequence Predictors

| | |
|---|---|
| while t ϵ [symbol] do | [symbol] Graphon Mean-field Euler-Maruyama Sampling |

```
    while i ≤ N do
      {yᵤ_{ᵢ}}, ≤ N ~ p(u, y), Δₜ ~ p(Δₜ), U ~ Unif( [symbol]  ), t ~ p(t).
        ${a}_{i} = a ( t , {X}_{i}^{n} ; {θ}^{*} ) , {W}_{ij} = {{W}_{a}}_{i} ( ⌈ {nu}_{i} ⌉ / n , ⌈ {nv}_{j} ⌉ / n ) , {ψ}_{ij} = {{ψ}_{a}}_{i} ( {X}_{i}^{n} ( t ) , {X}_{j}^{n} ( t ) ) .$
          $\text{?} ( t + {Δ}_{t} ) = \text{?} ( t ) + \text{?} {Δ}_{t} + b ( t , \text{?} ) {Δ}_{t} + 𝒩 ( \text{?} ) .$
```

| | |
|---|---|
| end while | [symbol] Predict Subsequent Future Event |

```
    if ϵ [symbol]   \ [symbol]   then
      ${Λ}_{t + {Δ}_{t}} = {\sum }_{i}^{K} w ( U , ⌈ {nu}_{i} ⌉ / n ) {X}_{i}^{n , {a}_{i}} ( t + {Δ}_{t} ) \approx {𝔼}_{u ∼ p ( u )} {X}_{u}^{α} ( t + {Δ}_{t} )$
    end if
end while
```

In an embodiment, due to the characteristics of infinite (or quasi-infinite) dimensions, sampling the mean-field predictor may cause inherently complex errors when applied to real-world datasets having finite dimensions. Mean-field predictors (MFPs) sampled by [Algorithm 1] and the MFPs of infinite dimensions may be defined as follows.

MFPs by [Algorithm 1]:

$${t}_{N}^{} := \frac{1}{N} {\sum }_{i}^{N} δ {x}_{i}^{n} ( t )$$

MFPs of infinite dimensions: \hat{μ}ₜ:= [symbol] _{u˜p(u)}[ [symbol] ᵤ(t)]

Here,

$${X}_{i}^{N} ( t ) \sim {i}_{N}^{}$$

denotes a sampled predictive variable obtained by implementing [Algorithm 1], and a weighted sum Λₜ may approximate an actual collective prediction performed by a mean-field predictive variable

$${𝔼}_{u} {X}_{u}^{α} ( t ) \sim {\hat{μ}}_{t} .$$

For any u∈ [symbol] , assuming

$${t}_{N}^{} , {\hat{μ}}_{t}$$

is a probability measure, for constants c, c₇, c₈, c₉>0, w>0, and [symbol] >0, the squared probability of the 2-Wasserstein distance may be controlled as follows.

$${sup}_{t ∈ T} ℙ [ {2}_{2}^{} ( {t}_{N}^{} , {\hat{μ}}_{t} ) \geq ϵ ] \leq \text{?} ( \frac{\text{?}}{\text{?}} + \frac{\text{?}}{N} {( 1 - \frac{128 ω \text{?} ( α )}{N} )}^{- d / 8} + \frac{1}{{72}^{4} ϵ \sqrt{N}} )$$

$$α = max ( {c}_{g} , \frac{2 {c}_{7}^{3 / 2}}{κ} exp ( {c}_{4} \text{?} ) ( \text{?} - 1 ) , {c}_{g} exp ( - 4 \text{?} ) ) .$$

$$\text{?} \text{indicates text missing or illegible when filed}$$

The above is a distribution of prediction results when sampling N times, and according to an embodiment, it can be confirmed that as the size of N increases, that is, as more samplings are performed, the reliability of the prediction results becomes greater.

FIG. 1B is a diagram illustrating a method of generating a future prediction through propagation according to an embodiment of the invention.

Referring to FIG. 1B, a processor may calculate a propagation signal of each of the plurality of observation data based on mean-field theory.

In an embodiment, mean-field theory (throughout the invention, the mean-field theory may be referred to as a mean-field principle or a mean-field game) may be used as a tool for probabilistically modeling and analyzing how many interacting agents dynamically behave in a distributed environment. In a mean-field domain, many agents may individually regulate dynamics of partially observed historical sequence data and may collectively interact with each other to make an optimal group decision for predicting future events, thereby satisfying a Nash equilibrium state. An embodiment of the invention relates to extending such a continuous time sequence prediction problem to a formal setting of the mean-field game.

In an embodiment, a mean-field graphon stochastic differential equation (SDE) may be used as a new framework for modeling a sequence predictor.

The mean-field graphon stochastic differential equation may be defined as in [Definition 1] below. [Equation 1] defined in [Definition 1] is a stochastic differential equation (SDE) designed to represent a continuous signal of infinite order by integrating inductive biases in time-series modeling.

### [Definition 1]

Definition 1. (Mean-field Graphon SDEs) For the Markovian feedback controls α: [symbol] × [symbol] ^{d}×Θ→ [symbol] ^{d} (i.e., α:=α(t, x: θ) and continuous labels v˜p w(u), we propose the [symbol] ^{d}-valued controlled stochastic differential equations called a mean field graphon dynamics defined as follows:

$$d \text{?} ( t ) 〈 \text{?} [ {v}_{} ( t ) ] ( u ) , ψ 〉 ( \text{?} ( t ) , α ) dt + b ( t , \text{?} ( t ) , α ) dt + \text{?} , \text{?} ( 0 ) := {y}_{u} , \qquad ( 1 )$$

$$\text{?} \text{indicates text missing or illegible when filed}$$

where a probability measure [symbol] := [symbol] serves as a concise representation of the law of dynamics, and yᵤ˜p(u, y) denotes a continuous representation of past observations.

$$[ Equation 1 ( or Eq . ( 1 ) ]$$

$$d \text{?} ( t ) = 〈 \text{?} [ {v}_{} ( t ) ) ] ( u ) , ψ 〉 ( \text{?} ( t ) , α ) dt + b ( t , \text{?} ( t ) , α ) dt + \text{?} d \text{?}$$

$$\text{?} \text{indicates text missing or illegible when filed}$$

In an embodiment, [Equation 1] focuses on 1) a mean-field predictor and 2) a neural graphon, which may be important for comprehensive and continuous time-series modeling. Hereinafter, a detailed description of the mean-field predictor and the neural graphon will be provided.

### 1) Mean-Field Predictor

A system according to an embodiment of the invention may include two types of continuity encodings. For example, the system may include an encoding for positionality (t) and an encoding for labeling (u).

In an embodiment, a continuum of predictors, or mean-field predictors (MFPs), may be represented as a state variable

$${X}_{u}^{a} ( t )$$

in [Equation 1]. The state variable

$${X}_{u}^{α} ( t )$$

may represent a set of continuous information trajectories, each labeled as u˜p(u) and initialized from past observations

$${X}_{u}^{α} ( 0 ) = {y}_{u} ∼ p ( u , y ) .$$

For example, in a mean-field regime

$${X}_{{u}_{∞}}^{α} ( 0 ) ,$$

the continuum of predictors for infinitely independent and identically distributed labels u_{∞}:={uₙ˜p(u); n≤N→∞} may be conditioned as a future causal effect for calculating

$${x}_{{u}_{\text{?}}}^{α} ( t )$$

$$\text{?} \text{indicates text missing or illegible when filed}$$

in a future event interval obtained from [Equation 1] according to a past observation interval, i.e., a label distribution p(u).

According to an embodiment of the invention, since both inputs and outputs are processed in a continuous manner, continuous signals may be processed through [Equation 1]. In a process of processing the continuous signals, a closed Markovian control process α(⋅; θ)∈ [symbol] parameterized by a neural network θ∈Θ may be referred to as a neural agent, which may control a trajectory of a state

$${X}_{{u}_{∞}}^{α} ( t ) .$$

An embodiment of the invention may correct a trajectory of the predictor by determining an optimal neural agent α* that most closely approaches a target interval. Through aggregation of decisions, collective behaviors of the mean-field predictors may be captured.

### 2) Neural Graphon

In time-series modeling, basic assumptions of inductive biases such as temporal decay, cycle, and seasonality are essential. In order to integrate the mean-field system of the invention, the neural graphon may be used. The neural graphon is a graphon structure parameterized by the neural network, and may capture inherent heterogeneity among prediction variables. In an embodiment, the neural graphon may include an exponential graphon, a cosinusoidal graphon, and the like.

In an embodiment, the neural graphon may be defined as [Definition 2] below.

Definition 2

Definition 2. (Neural Graphon) A graphon is a symmetric integrable function defined on L²,
W:O² → R equipped with L² norm. For a probability measure μ defined on O × R^{d} with
bounded second moment, we define a measure-valued function W_{α}[μ](•):O → M^{a} and a
continuous symmetric function ψ_{α}:= ψ(y, x, α):= H_{ψ}(α)Projₛ_{^{d−1}} (y − x) such that the first
term in right-hand side of Eq (1) is defined as [symbol]
W_{α}[μ](u), ψ_{α} [symbol] (y, α):= E_{v~p(v), x~μ}[Wα(u, v)ψ_{α}(y, x)] ∈ R^{d}.

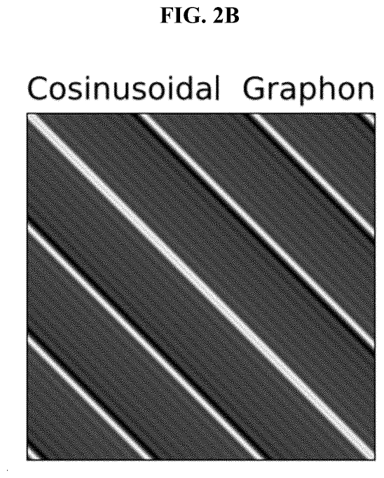

In an embodiment, for two tuples (x, u)˜vᵤ⊗p(u) and (y, v)˜v_{V}⊗p(v), a symmetric function ψ may measure a scaled relative difference between spatial features x and y. In addition, the neural agent H_{ψ}(α) may rescale a magnitude of a projected vector to adjust a weighting assigned to dissimilarity. The neural graphon W may encode a degree of interaction between time variables u and v. Among various available graphon designs, the exponential graphon (e.g., FIG. 2A) and the cosinusoidal graphon (e.g., FIG. 2B) may be used, which are respectively informed by inductive biases specialized for continuous time series. According to an embodiment of the invention, an inductive bias model may be directly modeled in a data space [symbol] ^{d} rather than in a latent feature space through the graphon structure.

According to an embodiment of the invention, it is possible to effectively capture probabilistic spatio-temporal dynamics of infinite agent continua based on prediction from time-series analysis (e.g., seasonality) by extending an existing differential equation model.

In an embodiment, the processor may generate a forward propagation signal and a backward propagation signal of each of the plurality of observation data using a symmetric integrable function of the neural graphon.

In an embodiment, in order to efficiently solve a mean-field game, the processor may calculate forward-backward stochastic differential equations (FBSDEs) by using gradient descent so as to significantly reduce computational complexity related to approximating a Nash equilibrium. The processor may generate a propagation signal of each of the plurality of observation data by solving a differential equation using gradient descent. According to the inventive concept, generating the propagation signal may include deriving a value obtained by solving a differential equation.

In an embodiment, the processor may incorporate updates from the neural agents using a gradient-descent-based algorithm. In an embodiment, for a fixed flow [symbol] ᵤ(⋅): [symbol] → [symbol] ₂ of measurements and a fixed label u at each step m, with respect to the graphon system of [Equation 1], a series of processes (Xᵤ(t), Yᵤ(t), Zᵤ(t)) may be defined as a gradient system solving the forward-backward stochastic differential equations, as shown in [Definition 3].

$${dX}_{\text{?}}^{\text{?}} ( t ) = {b}_{W} ( {X}_{\text{?}}^{\text{?}} ( t ) , {\text{?}}_{\text{?}} , {α}_{m} ) dt + b ( t , {X}_{\text{?}}^{\text{?}} ( t ) , {α}_{m} ) dt + {α}_{t} {dW}_{\text{?}}^{\text{?}} , \qquad [ Definition 3 ]$$

$${dY}_{\text{?}}^{\text{?}} ( t ) = - H ( t , {X}_{\text{?}}^{\text{?}} ( t ) , {Y}_{\text{?}}^{\text{?}} ( t ) , {\text{?}}_{\text{?}} , {α}_{m} ) dt - {Z}_{t}^{m} \cdot {dW}_{\text{?}}^{\text{?}} ,$$

$${α}_{m + 1} := α ( t , {X}_{\text{?}}^{\text{?}} ; {θ}^{m} - {𝔼}_{\text{?}} [ {γ}^{m} {∇}_{θ} {Y}_{\text{?}}^{\text{?}} ( t ) ] ) ∈ 𝔸 ,$$

$${𝓋}_{\text{?}} = Law ( {X}_{\text{?}}^{m - 1 , \text{?}} ) ,$$

$$\text{?} \text{indicates text missing or illegible when filed}$$

where γ^{m}>0 is a learning rate of gradient descent, and [symbol] is a set of admissible neural agents.

Accordingly,

$$( {X}_{u} ( t ) , {Y}_{u} ( t ) , {Z}_{u} ( t ) ) = 𝒥 , G , ( {\partial }_{\text{?}} 𝒥 ) {σ}_{t}^{- 1} )$$

$$\text{?} \text{indicates text missing or illegible when filed}$$

is obtained.

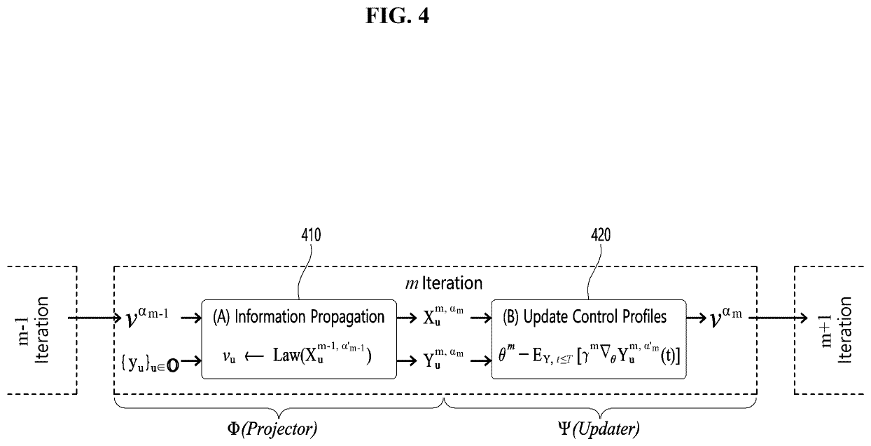

In an embodiment, the gradient system may decompose an equation by repeating, over a total of M steps, a two-step procedure of an information propagation step and an update step for updating a control profile. This will be described in more detail with reference to FIG. 4.

In an embodiment, the processor may determine an aggregation distribution by aggregating calculation results of the propagation signals for the plurality of observation data, and may determine a predicted value using the aggregation distribution. In addition, the processor may determine the aggregation distribution using an attention mechanism.

In an embodiment, in a training process, a predicted value corresponding to a collective decision of the mean-field predictors may be corrected to approximate an interval to a target future event. That is, the processor may determine a loss value based on a difference between the predicted value and a true value, and may train an artificial intelligence prediction model so that the loss value becomes less than or equal to a predetermined value (e.g., a very small value). If the training is performed until the loss value becomes less than or equal to the predetermined value, the artificial intelligence prediction model may be used as a predictor for predicting future information.

In an embodiment, in order for the artificial intelligence prediction model to generate an accurate target interval, the neural agent may be trained to derive a value function V characterizing a state in which a continuum of players form a coalition to cooperatively predict an optimal future event.

According to an embodiment of the invention, it is possible to clarify an influence of leakage in past observations on generalization performance of the mean-field system based on concentration of empirical measurements and propagation of chaotic properties. In addition, according to an embodiment of the invention, as the number of agents increases, accuracy may further increase, and reliable predictions may be generated.

FIG. 2A is a diagram illustrating an example of the exponential graphon according to an embodiment of the invention.

Referring to FIG. 2A, an example of the exponential graphon in which temporal decay for spatio-temporal variables is integrated such that an influence of past events exponentially decreases. FIG. 2A shows the exponential graphon in which temporally close events tend to exhibit strong interaction. Here, the neural agent W₁: [symbol] → [symbol] ⁺ may determine a magnitude of the interaction. For a deviation Δᵤ:=|u−v| among labels, an influence of temporally dissimilar events may have a penalty as shown in [Equation 2] below.

$${W}_{α} ( u , v ) := {W}_{1} ( α ) exp ( - {T}^{- 1} {Δ}_{u} ) \qquad [ Equation 2 ]$$

FIG. 2B is a diagram illustrating an example of the cosinusoidal graphon according to an embodiment of the invention.

Referring to FIG. 2B, an example of a cosinusoidal graphon that emphasizes a continuous cycle assumption capturing periodic characteristics of time-series is shown. In an embodiment, an eigendecomposition of the graphon operator in [symbol] ²( [symbol] ) may be performed using a sinusoidal eigenfunction {φₗ} and various frequency modes {λₗ} for an eigenvalue.

$$𝕎 = Id + {\sum }_{k , l ∈ {ℤ}_{+}} {λ}_{l} {φ}_{l} , \{ {ϕ}_{l} \} ⊂ \{ Id , \sqrt{2} cos 2 π k ( \cdot ) , \sqrt{2} sin 2 π k ( \cdot ) , \{ {λ}_{l} \} ⊂ \{ {a}_{0} , {b}_{k} / 2 \} \qquad [ Equation 3 ]$$

In an embodiment, by replacing a Fourier coefficient {Id, λₗ} with a corresponding neural agent (i.e., W₀, W_{1,l}, W_{2,l}: [symbol] → [symbol] ⁺), the graphon operator may be parameterized by a neural network. To represent various periods, a set of predetermined frequencies may be defined as f(l)∈{½, ¼, ⅛}ₗ≤L. In this case, the cosinusoidal graphon may be represented as [Equation 4] below.

$${W}_{α} ( u , v ) = {W}_{0} ( α ) - \frac{1}{2 L} {\sum }_{l ∈ \{ 1 , … , L \}} {W}_{1 , l} ( α ) cos ( \frac{2 π f ( l ) {Δ}_{u}}{\vert 𝒪 \vert} ) - {W}_{2 , l} ( α ) sin ( \frac{2 π f ( l ) {Δ}_{u}}{\vert 𝒪 \vert} ) \qquad [ Equation 4 ]$$

In an embodiment, for convenience of calculation, summation may be limited to a finite mode (L).

According to an embodiment, the mean-field system may formalize an objective function as a stochastic control problem by using a controlled stochastic differential equation with a neural agent.

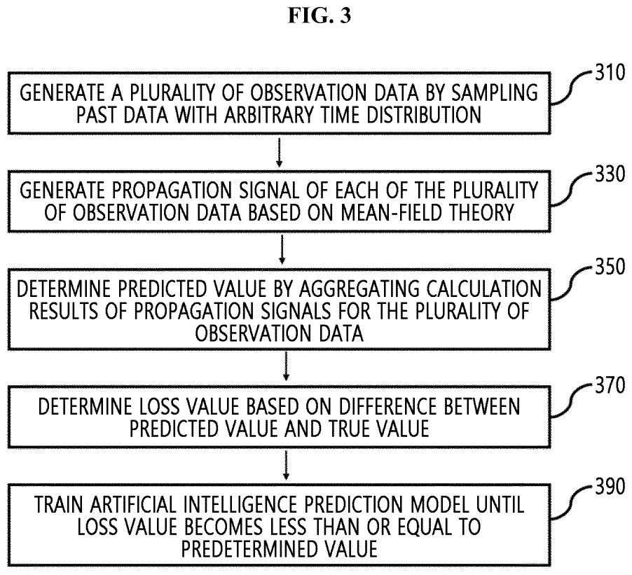

FIG. 3 is a flowchart of a prediction method using mean-field theory according to an embodiment of the invention.

Referring to FIG. 3, in operation 310, a processor may generate a plurality of observation data by sampling past data with an arbitrary time distribution. In an embodiment, the arbitrary time distribution may include an irregular or non-uniform distribution. Accordingly, a system according to an embodiment may perform accurate future prediction even for irregular time-series data by modeling dy values instead of y values.

In operation 330, the processor may generate a propagation signal of each of the plurality of observation data based on mean-field theory. In an embodiment, the processor may model an average movement of infinite or quasi-infinite observations based on mean-field theory. That is, the processor may determine information on what behavior patterns infinite or quasi-infinite observations will exhibit based on mean-field theory.

In an embodiment, the processor may generate a forward propagation signal based on the mean-field theory, and may generate a backward propagation signal based on the forward propagation signal. The processor may generate the forward or backward propagation signal and may evaluate the forward or backward propagation signal. In addition, the processor may update a control profile based on the backward propagation signal.

In an embodiment, the processor may generate a forward propagation signal of each of the plurality of observation data, and in operation 350, the processor may determine a predicted value by aggregating calculation results of the propagation signals for the plurality of observation data.

An embodiment of the invention may minimize a cost function [symbol] designed to train a neural agent and may derive a value function [symbol] .

In an embodiment, for a neural graphon [symbol] _{α} and a fixed set [symbol] of admissible control elements, the value function may be defined as in [Equation 5] below.

$$𝒱 := {inf}_{α ∈ 𝔸} 𝒥 ( {𝓋}^{α} , α ) = {inf}_{α ∈ 𝔸} {𝔼}_{α , 𝓋 , t} [ {‖ {𝔼}_{u ∼ p ( u )} {X}_{u}^{α} ( t ) - {y}_{t} ‖}_{E}^{2} + G ( {X}_{u}^{α} ( T ) , {𝓋}^{α} ) ] \qquad [ Equation 5 ]$$

Here, G denotes a final cost at time t=T, and w: [symbol] →[0, 1] denotes an aggregation function satisfying ∫w(u)du=1.

In an embodiment, to generate future prediction, a mean-field predictor may collaborate by forming a coalition, that is, a time difference

$${𝔼}_{u ∼ p ( u )} {X}_{u}^{α} ( t )$$

of the predictor. Here, an expectation for a label u may be used to aggregate a weighted decision (that is, w) for a continuum of prediction variables u˜p(u):=w_{#}[Unif( [symbol] )](u) approaching a target continuous interval {yₜ}_{t∈} [symbol] .

In an embodiment, the neural agent may be trained to derive a value function [symbol] characterizing a state in which a continuum of players form a coalition to cooperatively predict an optimal future event. The neural agent may affect a number of predictors [symbol] ^{α}, which in turn may continuously affect individual state variables as dynamics are propagated by interactions through the neural graphon. Accordingly, an embodiment may formalize a continuous sequence prediction problem as a mean-field game. An embodiment of the invention is directed to finding an optimal control variable α* that induces an optimal response in a recursive relationship between [symbol] and [symbol] . In an embodiment, by examining a forward-backward partial differential equation (FBPDE) system in a mean-field domain, an exact solution ( [symbol] , [symbol] ^{α*}) in an optimal control profile over time may be derived. In an embodiment, for an obtained optimal neural agent α*, the value function of [Equation 5] may be obtained by solving the following two PDEs.

### [Hamilton-Jacobi-Bellman (HJB) Equation]

$${\partial }_{t} 𝒱 ( t , x ) + {σ}_{t}^{2} / 2 Δ 𝒱 ( t , x ) + H ( t , x , {\partial }_{x} 𝒱 ( t , x ) , {𝓋}_{n} ( t ) , {α}^{*} ) = 0$$

### [Fokker-Planck-Kolmogorov (FPK) Equation]

$${\partial }_{t} {𝓋}_{n}^{{α}^{*}} ( t ) - {σ}_{t}^{2} / 2 Δ {𝓋}_{u}^{{α}^{*}} ( t ) + ∇ \cdot [ ( {b}_{W} ( x , {𝓋}_{u}^{{α}^{*}} ( t ) , {α}^{*} ) + b ( t , x , {α}^{*} ) ) {𝓋}_{u}^{{α}^{*}} ( t ) ] = 0 ,$$

Here, Δ and ∇ denote a Laplacian operator and a divergence operator, respectively.

In an embodiment, a stochastic Hamiltonian system H may be represented as [Equation 6] below.

$$H ( t , {x}_{u} , a , 𝓋 , α ) := ( {b}_{W} ( {x}_{u} , 𝓋 , α ) + b ( t , {x}_{u} , α ) ) \cdot a + {‖ {𝔼}_{u ∼ p ( u )} {x}_{u} - {y}_{t} ‖}^{2} \qquad [ Equation 6 ]$$

$$Here , {b}_{W} ( x , 𝓋 , α ) := 〈 {𝕎}_{α} [ 𝓋 ] ( u ) , ψ 〉 ( x , α )$$

denotes a graphon interaction term of [Definition 2].

In an embodiment, the HJB equation and the FPK equation may explain propagation rules of a state variable and a value function over time, respectively. In a mean-field equilibrium state, such PDEs may be combined by matching a law of a state variable, that is,

$$Law ( {X}_{u}^{α} ( t ) )$$

with a marginal error and [symbol] ᵤ(t). Such a mean-field equilibrium state may be represented as [Definition 4] below.

Definition 4

Definition 4. (Mean-field e-Equilibrium). We say that a continuous flow of
measure vᵤ(·) is an ϵ-equilibriumª of graphon mean-field games if there
exists a numerical constant ϵ > 0 such that
${sup}_{u , t} [ {W}_{2}^{2} ( {v}_{u} ( t ) , Law ( {X}_{u}^{{a}^{*}} ( t ) ) ] ≲ O ( ϵ ) , such that {a}^{*} ∈ A is optimal .$

In an embodiment, the mean-field equilibrium state may mean a state in which a continuum of the prediction variables has no incentive to change policies α* into non-optimal counterparts β that cause the marginal error. That is, the mean-field equilibrium state may mean a state of [symbol] ( [symbol] , [symbol] )≥ [symbol] ( [symbol] ^{α*}, α*). In an embodiment, an optimal mean-field predictor may approximate the population [symbol] ᵤ with a marginal error ϵ.

In an embodiment, solving the HJB equation and the FPK equation may be computationally difficult in nonlinearity such as a neural network. Accordingly, an embodiment of the invention may use a gradient system, which will be described below with reference to FIG. 4, to solve the above equations.

In operation 370, the processor may determine a loss value based on a difference between the predicted value and a true value, and in operation 390, the processor may train an artificial intelligence prediction model until the loss value becomes less than or equal to a predetermined value. In an embodiment, the artificial intelligence prediction model, after being trained until the loss value becomes less than or equal to the predetermined value, may be used as a predictor for predicting future information.

According to an embodiment of the invention, a mean-field continuous sequence predictor capable of efficiently generating a continuous sequence having complexity of quasi-infinite order may be provided. In addition, according to an embodiment of the invention, by using a graphon, a complex inductive bias in time-series data may be captured. In addition, to reconstruct a time-series forecasting problem as a mean-field game, to utilize a stochastic maximum principle, and to identify a Nash equilibrium, a gradient descent-based method and a virtual agent play approach may be used.

FIG. 4 is a diagram illustrating a gradient system of a mean-field predictor related to updated parameters of neural agents at an m-th iteration step according to an embodiment of the invention.

Referring to FIG. 4, the gradient system may include an information propagation step 410 and an update step 420 of a control profile.

In an embodiment, the information propagation step 410 may include providing population information of the previous step (m−1-th) to the neural agent performing the m-th iteration. In this case, through FBSDE, information on an updated population [symbol] ᵤ may be propagated as in [Equation 7] below.

$${u}_{} ← Law ( {X}_{u}^{m - 1 , {α}_{m - 1}^{*}} ) , ( {X}_{u}^{m} , {Y}_{u}^{m} ) \sim Law ( {X}_{u}^{m} \vert {u}_{} ) ⊗ Law ( {Y}_{u}^{m} \vert {u}_{} ) \qquad [ Equation 7 ]$$

In this case, backward propagation starts from a terminal state Yᵤ(T)=G, while forward propagation starts from an initial state, which means that this is parallel to a PDE system of [Definition 2].

In an embodiment, the update step 420 of the control profile may include performing an update with respect to a parameter θ^{m} along a steepest direction minimizing a backward dynamic value

$${Y}_{u}^{m}$$

using the neural agent α^{m}. Backward dynamics related to a cost function [symbol] may provide updates of parameters, thereby enabling the mean-field predictor to gradually approximate a target interval.

In an embodiment, the processor may provide [symbol] ^{α}^{ₘ} generated as a result of the m-th iteration to the neural agent performing the (m+1)-th iteration.

In an embodiment, when the information propagation step 410 and the update step 420 of the control profile are repeatedly performed m times, loss may be minimized to achieve an optimal prediction.

In an embodiment, the gradient system of [Definition 4] may derive an optimal neural agent α* causing a feasible function

$${Y}_{u}^{m} ( 0 ) {\to }^{m \to ∞}$$

$${lim}_{m \to ∞} H ( \cdot , {α}_{m} ) \approx {inf}_{α ∈ A} H ( \cdot , α ) , dt ⊗ d - a . e . , \approx {Y}_{u}^{∞} ( 0 ) = 𝒥 ( {{α}_{∞}}^{} , {α}_{∞} ) \qquad [ Equation 8 ]$$

In an embodiment, [Equation 8] shows that lim_{m→∞}α^{m}=α*, lim_{m→∞} [symbol] ^{α}^{ₘ}= [symbol] ^{α*} can solve both the HJB equation and the FPK equation, which probabilistically guarantees optimality.

In an embodiment, for convergence to equilibrium, a projector Φ and an updater Ψ: [symbol] → [symbol] may be represented as [Equation 9] and [Equation 10], respectively.

$$Φ ( {{α}_{m}}^{} ) := \{ Law ( {X}_{u}^{{a}_{m}} ( t ) ) {\vert}_{= {{α}_{m - 1}^{*}}^{}} ; t ∈ , u ∈ 𝒪 \} \qquad [ Equation 9 ]$$

$$Ψ ( {{α}_{m - 1}}^{} ) := \{ {{α}_{m}}^{} ; = 𝒥 ( {{α}_{m - 1}^{*}}^{} , {α}_{m - 1}^{*} ) , {{α}_{m}}^{} \text{=\vert} {α}_{m - 1}^{*} \} \qquad [ Equation 10 ]$$

At step m, a configuration of such operators may map population information of a previous state to a next step ΦôΨ( [symbol] ^{m-1})= [symbol] ^{m}. That is, a population { [symbol] ^{α}^{ₘ}} m≤M generated according to the above algorithm may converge in a Wasserstein metric as the step m increases.

According to an embodiment, when the iteration is sufficiently performed m times, the mean-field game can be efficiently used in continuous sequence prediction through convergence of the gradient system.

The prediction method according to an embodiment of the invention can be confirmed to outperform other methods as shown in [Table 1] below.

TABLE 1

| | MIT Humanoid Robot | | MIMIC-II | | Beijing Air Quality | |
|---|---|---|---|---|---|---|
| Methods | MSE | MAE | MSE | MAE | MSE | MAE |
| Neural Laplace | 8.11 ± 0.25 | 17.03 ± 0.33 | 7.76 ± 0.04 | 18.70 ± 0.08 | 3.21 ± 0.12 | 11.45 ± 0.23 |
| MaSDEs | 16.51 ± 0.21 | 27.89 ± 0.30 | 8.41 ± 0.06 | 20.67 ± 0.08 | 3.47 ± 0.03 | 13.13 ± 0.07 |
| CRU | 32.08 ± 5.07 | 42.50 ± 3.90 | 13.09 ± 0.31 | 24.68 ± 0.47 | 3.48 ± 0.06 | 12.76 ± 0.19 |
| Latent SDE | 6.01 ± 0.14 | 15.94 ± 0.14 | 8.04 ± 0.02 | 19.63 ± 0.06 | 3.29 ± 0.03 | 11.99 ± 0.07 |
| Neural LSDE | 6.80 ± 0.14 | 16.51 ± 0.08 | 7.93 ± 0.05 | 19.09 ± 0.07 | 3.74 ± 0.04 | 11.98 ± 0.15 |
| CONTIME | 6.88 ± 0.29 | 16.60 ± 0.25 | 12.29 ± 0.14 | 25.26 ± 0.12 | 5.15 ± 0.17 | 15.86 ± 0.27 |
| Contiformer | 5.94 ± 0.23 | 15.29 ± 0.26 | 7.90 ± 0.12 | 19.05 ± 0.18 | 3.25 ± 0.10 | 11.48 ± 0.16 |
| S4 | 5.59 ± 0.16 | 13.98 ± 0.19 | 13.24 ± 0.01 | 24.79 ± 0.30 | 3.95 ± 0.15 | 12.35 ± 0.17 |
| Mamba | 5.21 ± 0.09 | 13.71 ± 0.15 | 13.23 ± 0.02 | 24.76 ± 0.19 | 3.68 ± 0.14 | 11.56 ± 0.24 |
| MFPs (Exp.) | 3.89 ± 0.10 | 11.42 ± 0.14 | 7.51 ± 0.08 | 18.59 ± 0.11 | 3.14 ± 0.07 | 11.45 ± 0.13 |
| MFPs (Cosin.) | 3.91 ± 0.07 | 11.43 ± 0.07 | 7.51 ± 0.06 | 18.60 ± 0.10 | 3.13 ± 0.07 | 11.38 ± 0.08 |

The artificial intelligence prediction model sufficiently trained by the above-described method with reference to FIGS. 1A to 4 may be used to learn future data. Hereinafter, a method of predicting future data using the artificial intelligence prediction model trained by the above-described method with reference to FIGS. 1A to 4 will be described.

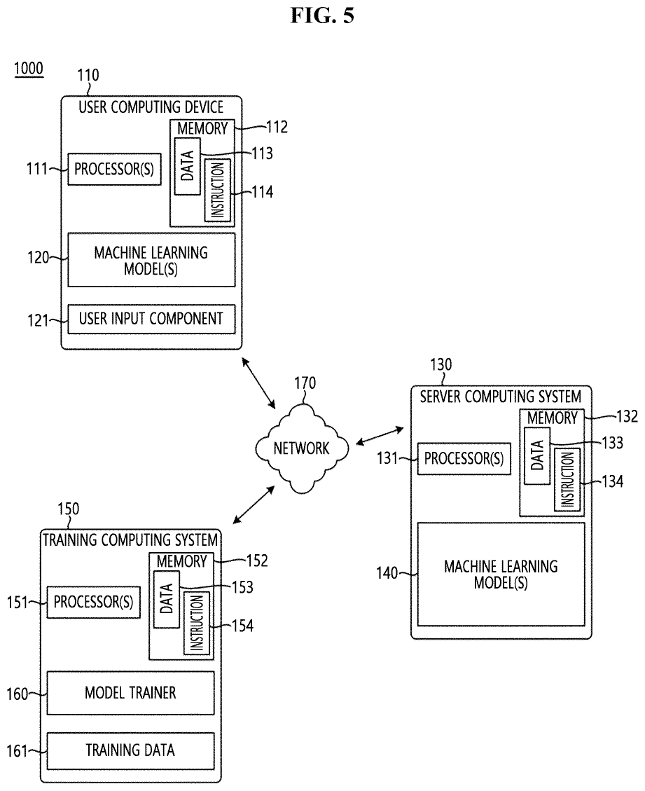

FIG. 5 is a block diagram of a computing system for performing the method of predicting future data according to an embodiment of the invention.

Referring to FIG. 5, a computing system 1000 for predicting future data according to an embodiment of the invention includes a user computing device 110, a training computing system 150, and a server computing system 130, and each device and system may be communicatively connected through a network 170. According to the inventive concept, future data to be predicted may also be referred to as a target.

In an embodiment, the user computing device 110 may perform the prediction method of future data using a local and/or external machine learning model 120 or a machine learning model 140 provided by a server. The machine learning models 120 and 140 of FIG. 5 may correspond to the artificial intelligence prediction model described above with reference to FIGS. 1A to 4. The machine learning models 120 and 140 may include the model trained by the training computing system 150 according to the training method described above with reference to FIGS. 1A to 4.

In another embodiment, the server computing system 130 communicating with the user computing device 110 may provide a future data prediction service to the user computing device 110 on an application and/or on the web according to a user request through the user computing device 110.

In another embodiment, the user computing device 110 and the server computing system 130 may cooperatively perform at least part of the method of performing future data prediction to provide the future data prediction service to a user.

In addition, according to embodiments, the user computing device 110 and/or the server computing system 130 may train the machine learning models 120 and 140 used for future data prediction through interaction with the training computing system 150 communicatively connected through the network 170. Accordingly, the training computing system 150 may be separate from the server computing system 130 or may be a part of the server computing system 130.

In embodiments, the training computing system 150 may be a part of the server computing system 130 or a part of the user computing device 110.

The user computing device 110 accesses the server computing system 130 to execute a prediction task, the server computing system 130 either directly or by using a model of another separate server collects and analyzes data required for future data prediction, and performs future forecast prediction based on the collected and analyzed data. However, a case in which a part of a process described as being performed in the server computing system 130 is performed in the user computing device 110 may be included in the description of the present invention.

The user computing device 110 may include all types of computing devices such as a smart phone, a mobile phone, a digital broadcasting device, a personal digital assistant (PDA), a portable multimedia player (PMP), a desktop, a wearable device, an embedded computing device, and/or a tablet PC.

Such a user computing device 110 includes at least one processor 111 and a memory 112. Here, the processor 111 may include at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of processors electrically connected thereto.

The memory 112 may include one or more non-transitory/transitory computer-readable storage media such as a RAM, a ROM, an EEPROM, an EPROM, a flash memory device, a magnetic disk, and a combination thereof, and may include web storage of a server that performs a storage function of the memory on the Internet. Such a memory 112 may store data and instructions required for the at least one processor 111 to perform an operation of an application for performing a target prediction.

In an embodiment, the user computing device 110 may store at least one machine learning model 120. For example, the user computing device 110 may include various machine learning models such as a plurality of neural networks (e.g., a deep neural network) for performing prediction of future data (target) based on structured/quantitative data, or other types of machine learning models including nonlinear models and/or linear models, or a combination thereof. In an embodiment, the machine learning models 120 may include an artificial intelligence prediction model trained by generating a plurality of observation data by sampling past data with an arbitrary time distribution, generating a propagation signal of each of the plurality of observation data based on mean-field theory, determining a predicted value by aggregating calculation results of the propagation signals for the plurality of observation data, and determining a loss value based on a difference between the predicted value and a true value.

For example, the prediction model may include linear regression, decision tree, random forest, gradient boosting, pre-trained language models, and/or deep learning models. And the neural network may include at least one of feed-forward neural networks, recurrent neural networks (e.g., long short-term memory recurrent neural networks), convolutional neural networks, and/or other types of neural networks.

In addition, the user computing device 110 may store a model to be used in each process performed for future data prediction and a prompt template serving as a basis of input to the model. For example, the user computing device 110 may store 1) a prompt for generating a query from a user input, 2) a prompt for determining a relationship between future data (target) and future data (target) influence variables, 3) a prompt for identifying raw data associated with the determined relationship, 4) a prompt template for quantifying unstructured data, and the like.

That is, in an embodiment, the user computing device 110 may perform future data prediction based on data received by requesting that some steps in the future data prediction task be performed by an external server through a prompt or the like.

In another embodiment, for the future data prediction task requested through the user computing device 110, the server computing system 130 may perform future data prediction through at least one machine learning model 140 and a machine learning model of another server and may provide the predicted data to the user computing device 110.

Such a user computing device 110 may include at least one input component 121 that detects a user input. For example, the user input component 121 may include a touch sensor (e.g., a touch screen and/or a touch pad) for sensing a touch of a user's input medium (e.g., a finger or a stylus), an image sensor for sensing a user's motion input, a microphone for sensing a user's voice input, a button, a mouse, and/or a keyboard. In addition, when receiving an input from an external controller (e.g., a mouse, a keyboard, etc.) through an interface, the user input component 121 may include the interface and the external controller.

The server computing system 130 includes at least one processor 131 and a memory 132.

Here, the processor 131 may include at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of processors electrically connected thereto.

The memory 132 may include one or more non-transitory/transitory computer-readable storage media such as a RAM, a ROM, an EEPROM, an EPROM, a flash memory device, a magnetic disk, or a combination thereof. Such a memory 132 may store a prompt template required for the processor 131 to perform a task through a language model of the server computing system 130 and/or a language model of an external server, and data and instructions required for the machine learning model 140 and the like to predict a future. For example, the server computing system 130 may include a neural network and/or other multi-layer nonlinear models as the machine learning model 140 for future prediction. An exemplary neural network may include a feed-forward neural network, a deep neural network, a recurrent neural network, and a convolutional neural network.

In an embodiment, the server computing system 130 may be implemented to include at least one computing device. For example, the server computing system 130 may be implemented to operate a plurality of computing devices according to a sequential computing architecture, a parallel computing architecture, or a combination thereof. In addition, the server computing system 130 may include the plurality of computing devices connected through a network.

In an embodiment, the server computing system 130 may further include a data store computing system (hereinafter, data store), which is a repository for continuously storing and managing raw data serving as a basis of future prediction for future data (target). Such a data store may include various types of data repositories ranging from a file system to cloud storage.

For example, the data store may include at least one database of a relational database that uses a structured query language (SQL) to define and manipulate data, a NoSQL database that is designed for flexibility and scalability to process unstructured and semi-structured data, a data warehouse that is used for reporting and data analysis by centralizing large volumes of data from multiple sources and optimizing them for queries and analysis, a data warehouse that stores large amounts of raw data in basic formats of structured data, semi-structured data, and unstructured data, and a local storage device or network attached storage (NAS) that stores data in a file format generally accessible from a computer operating system.

The training computing system 150 includes at least one processor 151 and a memory 152. Here, the processor 151 may include at least one of a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions, or a plurality of processors electrically connected thereto. In an embodiment, the training computing system 150 may train an artificial intelligence prediction model by generating a plurality of observation data by sampling past data with an arbitrary time distribution, generating a propagation signal of each of the plurality of observation data based on mean-field theory, determining a predicted value by aggregating calculation results of the propagation signals for the plurality of observation data, and repeatedly performing determination of the predicted value by aggregating the calculation results of the propagation signals s for the plurality of observation data. For example, the training computing system 150 may train the artificial intelligence prediction model by repeatedly performing the operation until a calculated loss value becomes less than or equal to a predetermined value.

The memory 152 may include one or more non-transitory/transitory computer-readable storage media such as a RAM, a ROM, an EEPROM, an EPROM, a flash memory device, a magnetic disk, or a combination thereof.

The memory 152 may store data and instructions required for the processor 151 to train a future prediction model.

For example, the training computing system 150 may include a model trainer 160 for training artificial intelligence models stored in the user computing device 110 and/or the server computing system 130 by using various training or learning techniques such as backward propagation of an error.

For example, the model trainer 160 may perform updating of one or more parameters of a machine learning model for future prediction in a backward propagation method based on a defined loss function.

In some implementations, performing backward propagation of the error may include performing truncated backpropagation through time. The model trainer 160 may perform multiple generalization techniques (e.g., weight decay, dropout, knowledge distillation, etc.) to improve generalization ability of a fusion-casting model to be trained.

The model trainer 160 may include computer logic utilized to provide desired functions. The model trainer 160 may be implemented as hardware, firmware, and/or software that control a generic-purpose processor. For example, in an embodiment, the model trainer 160 may include program files stored in a storage device, which may be loaded into a memory and executed by one or more processors. In another implementation, the model trainer 160 may include one or more sets of computer-executable instructions stored in a tangible computer-readable storage medium such as a RAM, a hard disk, or an optical or magnetic medium.

The network 170 may include a 3rd generation partnership project (3GPP) network, a long term evolution (LTE) network, a world interoperability for microwave access (WiMAX) network, the internet, a local area network (LAN), a wireless LAN (WLAN), a wide area network (WAN), a personal area network (PAN), a Bluetooth network, a satellite broadcasting network, an analog broadcasting network, and/or a digital multimedia broadcasting (DMB) network, but is not limited thereto. In general, communication through the network 170 may be performed by using any type of wired and/or wireless connections through various communication protocols (e.g., TCP/IP, HTTP, SMTP, FTP), encodings or formats (e.g., HTML, XML), and/or protection schemes (e.g., VPN, secure HTTP, SSL).

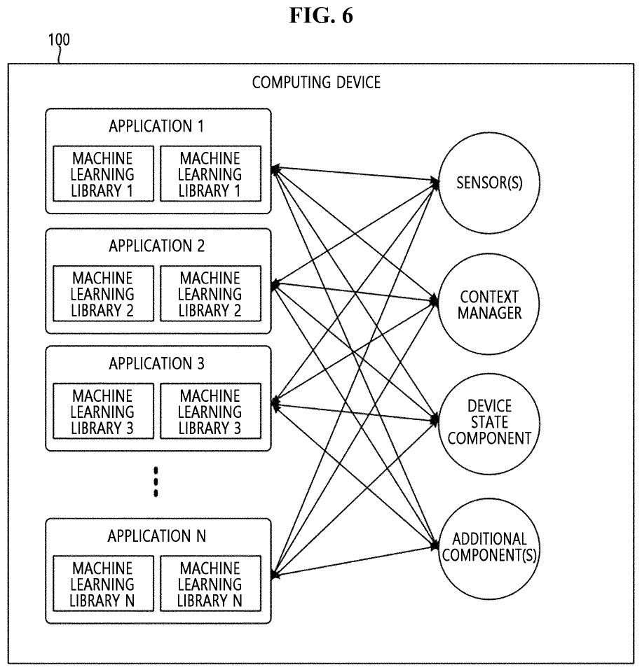

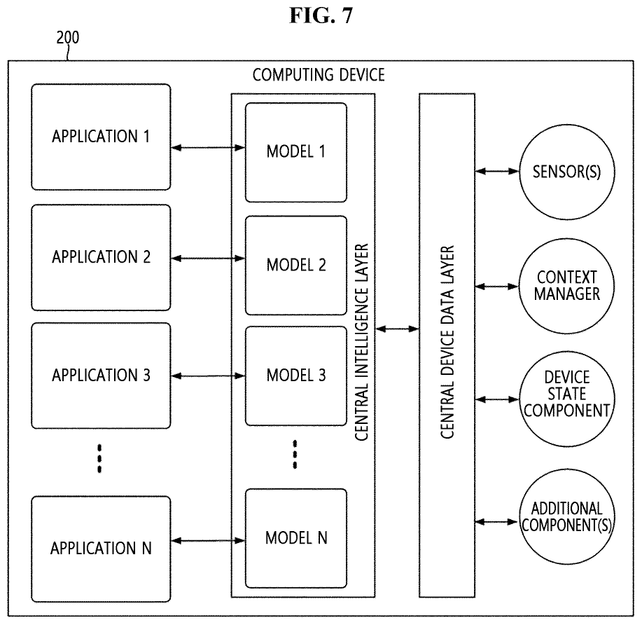

FIG. 6 is a block diagram of a computing device, which is one configuration of the computing system 1000 for performing the method of predicting future data according to an embodiment of the invention.

Referring to FIG. 6, a computing device 100 included in the user computing device 110, the server computing system 130, and the training computing system 150 includes multiple applications (e.g., application 1 to application N). Each application may include machine learning libraries. For example, the applications may include a future prediction application, a text messaging application, an email application, a dictation application, a virtual keyboard application, a browser application, a separate future prediction application, and the like. In an embodiment, the computing device 100 may include the model trainer 160 for training a future prediction model, and may store and operate the future prediction model to perform a future data prediction task on input data.

Each application of the computing device 100 may communicate with multiple other components of the computing device such as one or more sensors, a context manager, a device state component, and/or additional components. In an embodiment, each application may communicate with each device component by using an API (e.g., a public API). In an embodiment, the API used by each application may be specific to the corresponding application.

FIG. 7 is a block diagram of another aspect of the computing device, which is one configuration of the computing system 1000 for performing the method of predicting future data according to an embodiment of the invention.

Referring to FIG. 7, a computing device 200 includes multiple applications (e.g., application 1 to application N). Each application may communicate with a central intelligence layer. For example, the applications may include an image processing application, a text messaging application, an email application, a dictation application, a virtual keyboard application, a browser application, and the like. In an embodiment, each application may communicate with the central intelligence layer (and models stored therein) by using an API (e.g., a common API across all applications). The central intelligence layer may include prompts using multiple machine learning models and/or language models. For example, as shown in FIG. 7, at least some of the machine learning models may be provided for each application and managed by the central intelligence layer. In another implementation, two or more applications may share a single machine learning model. For example, in some implementations, the central intelligence layer may provide a single model for all applications. In some implementations, the central intelligence layer may be included in an operating system of the computing device 200 or otherwise implemented.

The central intelligence layer may communicate with a central device data layer. The central device data layer may be a centralized data repository for the computing device 200. As shown in FIG. 7, the central device data layer may communicate with multiple other components of the computing device such as one or more sensors, a context manager, a device state component, and/or additional components. In some implementations, the central device data layer may communicate with each device component by using the API (e.g., a private API). The techniques described herein may refer to a server, a database, software applications, and other computer-based systems as well as actions taken and information transmitted to or from the system. It will be recognized that inherent flexibility of computer-based systems allows a wide range of possible configurations, combinations, partitioning of tasks, and functionality among and from components. For example, the processes described herein may be implemented by using a single device or component, or multiple devices or components operating in combination. The databases and the applications may be implemented in a single system or in distributed systems across multiple systems. Distributed components may operate sequentially or in parallel.

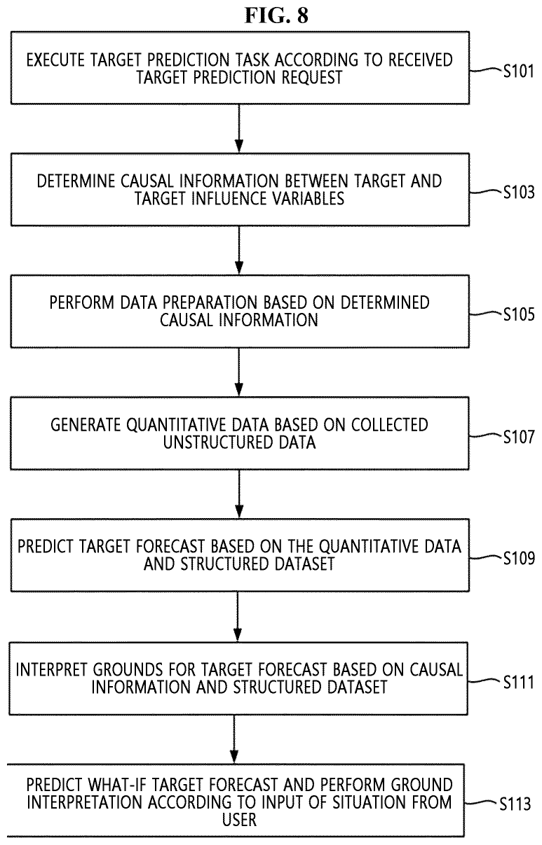

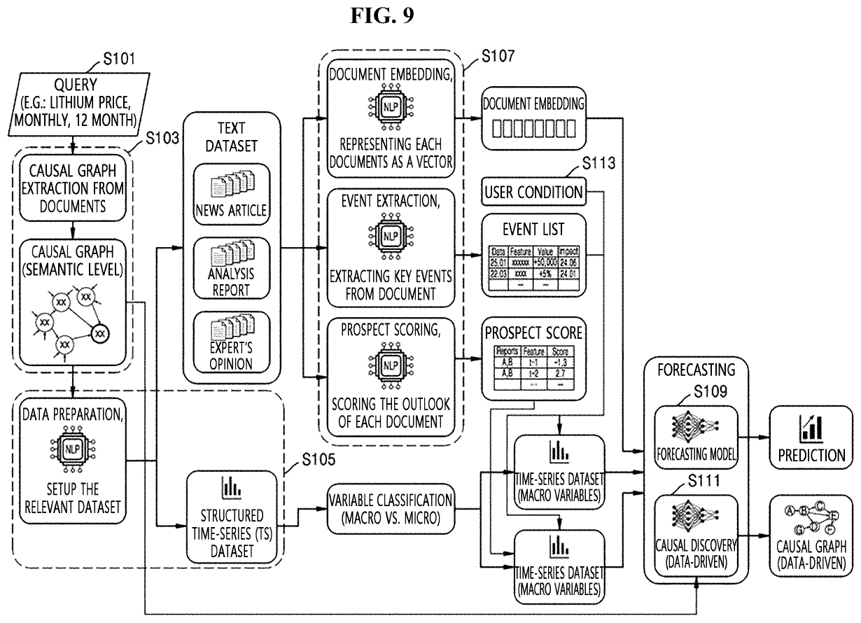

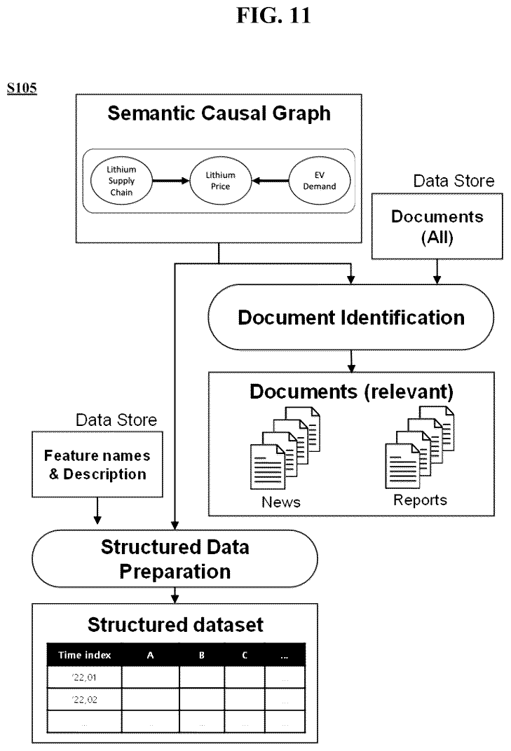

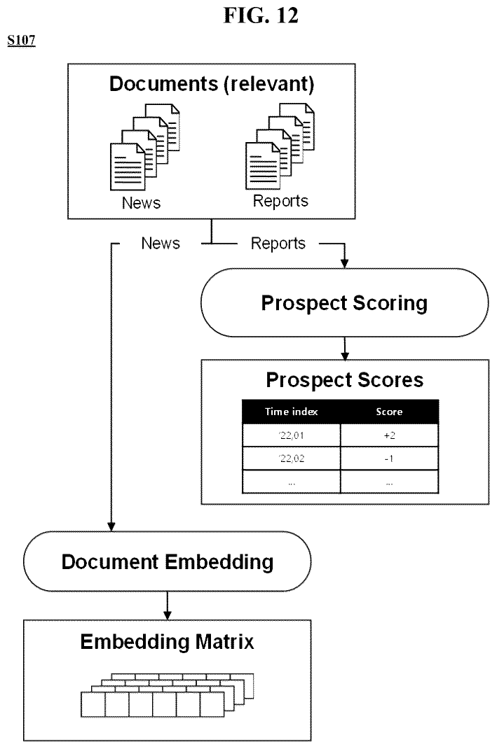

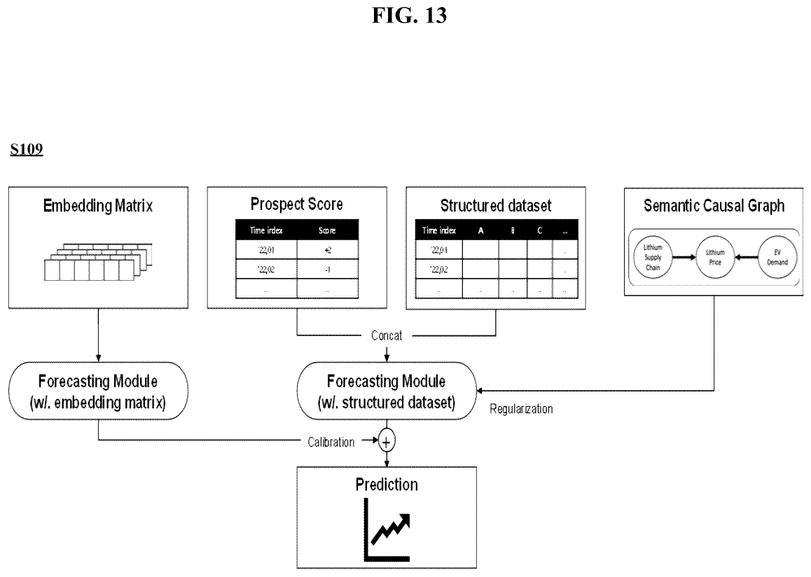

In an embodiment, the computing system 1000 may collect past data (or raw data), analyze the collected past data to predict a forecast of a target, and provide relationship information serving as grounds for the forecast prediction. This will be described in more detail with reference to FIGS. 8 to 19.

FIG. 8 is a flowchart of a method of predicting a forecast of a target through a machine learning model according to an embodiment of the invention.

In operation S101, a target prediction request may be received from the user computing device 110 of the computing system 1000, and a target prediction task may be executed according to the received target prediction request. In an embodiment, the user computing device 110 may receive a text-based target prediction request from a user through a chat interface, transmit text including the target prediction request to the server computing system 130, thereby enabling the server computing system 130 to execute a target prediction task.

The server computing system 130 may execute the target prediction task when detecting a pre-stored phrase for the target prediction request from the text input through the chat interface or detecting a context of the target prediction request by analyzing the text based on context.

And the server computing system 130 may recognize the text including the target prediction request to determine a target prediction element for target prediction.

Here, the target prediction element may include a target to be predicted, and may further include at least one of a total prediction length to be predicted and a prediction unit time. Throughout the invention, “target” may be referred to as “future data.”

In an embodiment, the target may be related to a numerical value that varies over time, and predicting the target may mean predicting and calculating the numerical value of the target at future predetermined time points, at intervals of the prediction unit time, up to the total prediction length.

Specifically, the server computing system 130 may analyze the text of the target prediction request, insert the text into a query generation prompt template for determining the target prediction element, input the template into a language model, and determine the target prediction element by receiving at least one of the target prediction elements as output from the language model.

For example, the query generation prompt template may be configured to input “the text of the target prediction request” into a dialog-type prediction request field as an input, to recognize values corresponding to the target, the total prediction length, and the unit time based on named entity recognition (NER) as an operation, and to return the target, the total prediction length, and the unit time of a query as output values.

As a more specific example, when a user inputs the target prediction request text such as “predict lithium prices for the next 12 months on a monthly basis,” the server computing system 130 may input <<Input: dialog-type prediction request “Predict how the lithium price will change on a monthly basis over the next 12 months,” Operation: recognize values corresponding to a target, a total prediction length, and a unit time for the input text through NER to generate and return the following query, Output: query—{Target:, Unit time:, Total prediction length:}>>into the language model as a prompt to determine the target prediction element by outputting the target prediction element as {Target: lithium market price, Unit time: monthly, Total prediction length: 12 months}. In this case, when the target prediction element is not specified or abstract, the server computing system 130 may provide a separate future prediction interface for inputting the target prediction elements for target prediction, receive the target prediction elements input through the provided future prediction interface, and execute the target prediction task. That is, when the target is classified from higher-level to multiple lower-level concepts according to categories, the server computing system 130 may list target keywords mapped to the higher-level and lower-level concepts and provide them for user selection.

For example, the future prediction interface may provide the target keywords derived through the NER sequentially from the higher-level concept to the lower-level concept for user selection, thereby enabling the user to more accurately determine the target to be predicted.

When the target prediction element is determined, the server computing system 130 may determine causal information between the target and target influence variables. In operation S103, the server computing system 130 may collect target analysis data for the target. This may be performed by filtering data in the data store in the server computing system 130 or by crawling data existing on the Internet.

For example, the server computing system 130 may detect the target analysis data by performing keyword search based on a keyword representing the determined target. Here, the target analysis data may be target analysis reports related to the target.

Specifically, the server computing system 130 may request the language model to return analysis reports by searching analysis data associated with the target based on the keyword of the target, using a target analysis report collection prompt template preset in the language model.

More specifically, the server computing system 130 may obtain the target analysis reports as output by using the target analysis report collection prompt template with <<Input: Target—lithium market price, Operation: search and return analysis reports having titles associated with the target through keyword search>>.

When obtaining such target analysis reports, the server computing system 130 may record a reference of the target so as to extract semantic information about the target. And the server computing system 130 may detect target influence variables affecting the target from the collected target analysis data, analyze the causal information between the target influence variables and the target, and generate the causal information.

In an embodiment, the causal information may include information about the target influence variables affecting future prediction of the target and information about a causal relationship between the target influence variables and the target.

More specifically, the information about the target influence variables may refer to information defining the target influence variables at a semantic level, and the information about the causal relationship between the target and the target influence variables may refer to information such as temporal order that exerts influence, proportion of influence, weight, or the like between the target and the target influence variables and between the target influence variables.

In an embodiment, the server computing system 130 may generate the causal information by analyzing a semantic causal graph at the semantic level as correlation information between the target and the target influence variables based on the collected target analysis data.

To this end, in an embodiment, the server computing system 130 may perform topic-relevant terms recognition on the target analysis data to detect and annotate the target influence variables associated with the target in the target analysis data.

And the server computing system 130 may generate a causal graph at the semantic level by inputting the target analysis data annotated with the target and the target influence variables into a causal graph generation model trained to generate the causal graph between the target and the target influence variables.

Here, the causal graph between the target and the target influence variables may include information defining the target and the target influence variables at the semantic level in nodes together with node names.

For example, information for determining the target and the target influence variables at the semantic level may include a name, a keyword, a source, a domain, a region, a location, and a characteristic of the corresponding element as additional annotations.

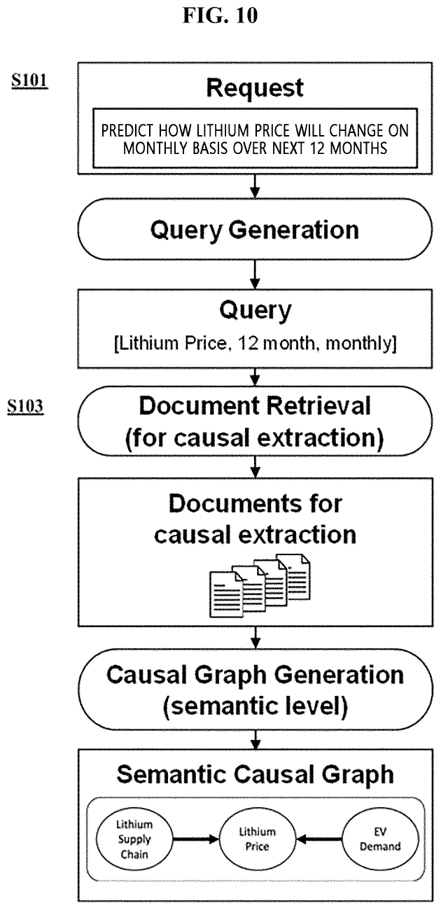

And referring to FIG. 10, the causal graph between the target and the target influence variables may include, through arrows, information about causal relationship on whether each node (the target and the target influence variables) exerts influence on another node in a preceding manner or in a succeeding manner.

In an embodiment, the server computing system 130 may collect the target analysis data based on context and perform a process of outputting the causal information between the target and the target influence variables based on the collected target analysis data through a retrieval augmented generation (RAG) model.

Here, the RAG model may operate as a kind of module activated to input up-to-date information into a large language model (LLM) according to an embodiment of the invention.

In detail, the RAG model may operate to detect more target influence variables among infinitely many pieces of information related to at least one target prediction element included in the target prediction request received from the user computing device 110.

For example, the RAG model may be one of a naive RAG, an advanced RAG, and a modular RAG. By taking the advanced RAG model as an example, a pre-retrieval process may remove unnecessary information and special characters to enhance data granularity, optimize an index structure by adjusting chunk sizes and changing index paths, and add metadata such as date and purpose to each data chunk, thereby refining the data.

In addition, an embedding model may be adjusted to improve relevance between a user's question and retrieved contents through fine-tuning embedding and/or dynamic embedding. In addition, a post-retrieval process may combine important context among the retrieved content with the user's question to input into the LLM, rearrange the retrieved content in order of relevance, and compress prompts according to importance, thereby refining the data.

Such a RAG model may be a model combining a pre-trained parametric memory (e.g., a sequence-to-sequence (seq2seq) model) and a non-parametric memory (e.g., a dense vector index of Wikipedia). The parametric memory may perform retrieval by conditioning on the same phrase across an entire sequence, and the non-parametric memory may perform retrieval by conditioning on different phrases for each token.

Accordingly, the RAG model may generate more specific and diverse, fact-based language excluding unnecessary information through the LLM.

Through a process of generating the causal information according to such an embodiment, the target influence variables may be clearly identified and defined at the semantic level by concept, category, topic, and/or a specific criterion, and contexts and domains related to the target influence variables at the semantic level may be accurately determined. And the information defined in this manner may be annotated to the target influence variables and utilized to perform data preparation at the semantic level thereafter, thereby accurately identifying raw data necessary for target prediction. In operation S105, when the causal information between the target and the target influence variables is determined, the server computing system 130 may perform a data preparation step based on the determined causal information.

First, the server computing system 130 may collect raw data related to the target and the target influence variables of the causal information for forecast prediction of the target.

In an embodiment, the server computing system 130 may collect unstructured data (e.g., news articles, analysis reports, etc. that are composed of text) and structured data related to the target and the target influence variables through a keyword search representing the target and the target influence variables, and may store the collected raw data in the data store.

In other words, the server computing system 130 may store vectors defined through unstructured data and structured data in a vector database.

And the server computing system 130 may determine whether the raw data stored in the data store has relevance to target influence variables at the semantic level, and may extract relevant data. In this case, the raw data may be filtered according to whether or not it matches semantic definitions included in the above-described the target and target influence variables, thereby obtaining prediction base data necessary for target prediction.

For example, the server computing system 130 may cause a document for determination to be input as an input, and may cause relevance to the target influence variables at the semantic level to be output as an operation, thereby extracting the prediction base data having relevance to the target and the target influence variables at the semantic level from the raw data.

In order to identify data related to the target influence variables affecting the target, past data analysis knowledge and domain expertise in the field related to the target are important. To complement this, the server computing system 130 may derive events related to the target and events unrelated to the target through the language model.

For example, the server computing system 130 may instruct the language model through a related/unrelated event generation prompt including a phrase instructing the model to operate as a domain expert for the corresponding target, thereby returning a plurality of related events that affect changes in the target at the semantic level and a plurality of unrelated events that either do not affect the changes or affect the changes below a reference level.

Specifically, the server computing system 130 may instruct the language model, through the related/unrelated event generation prompt including information defining each target influence variable at the semantic level, to distinguish, in the prediction base data, related events that affect the target and unrelated events.

And the server computing system 130 may generate a document identification prompt for classifying and identifying the prediction base data from the raw data through the returned related/unrelated events, and may request the language model to perform document classification on the raw data based on the generated document identification prompt, thereby accurately extracting the prediction base data related to the target and the target influence variables.

In addition, unstructured data related to the forecast of the target may be detected from the prediction base data related to the target and/or the target influence variables. That is, the server computing system 130 may classify documents related to the target and/or the target influence variables from the raw data stored in the data store, and detect related events and/or sentences that affect the target from the documents.

For example, a document classification prompt may be configured to: 1) instruct to predict the target as an expert in the target; 2) input at least one document to be identified, included in the raw data, as input data; 3) instruct an operation to select one of a related event option associated with prediction of the target and an unrelated event option that does not affect the target in the document; and 4) add a related event that affects the target among information in the document to the related event option or add an unrelated event that does not affect the target to the unrelated event option.

As a specific example, when an element to be predicted is “lithium production,” the server computing system 130 may identify whether a document of raw data is related to “lithium production” through a prompt configured as <<1) Please act as a lithium expert. 2) Input: [document] 3) Classify [document] related to an increase or decrease of lithium production. Your answer has two options. —Option 1: High relevance (related event list), —Option 2: No relevance (unrelated event list). 4) First, describe how and why the provided information is related to an increase or decrease in lithium production. Then place the option number in the last line.>>.

That is, the server computing system 130 may collect the raw data related to the target and/or the target influence variables, classify the prediction base data related to the target and/or the target influence variables from the raw data, and determine the related events and sentences that affect the forecast of the target from the classified prediction base data, thereby filtering the sentences and related events associated with the forecast of the target as unstructured data from the raw data.

Next, the server computing system 130 may identify and classify, by using the language model, whether each feature stored in the data store belongs to relevant target influence variables (semantic variables), and may generate a structured dataset composed of structured data on the related features. Here, a feature refers to an attribute of data stored in a structured data format as various factors that may affect the forecast of the target, and may include, for example, a CSV, an Excel file, and/or a table.

For example, when the target is the lithium price, the target influence variables may refer to variables associated with the lithium price such as “spodumene, lithium mine, lithium salt lake, lithium carbonate, lithium hydroxide, and lithium batteries,” and the features may be structured data belonging to the target influence variables and affecting the forecast of the target, such as “Australia spodumene production volume, Australia spodumene export volume, Chile lithium hydroxide production volume, Chile lithium hydroxide export volume, China spodumene import volume, China lithium carbonate import volume, China lithium carbonate production volume, China lithium carbonate sales volume, lithium battery efficiency (km/Wh), China electric vehicle sales volume, and China electric vehicle subsidy plan.”

That is, in an embodiment, the target influence variables may be a specific concept, topic, or category that affect the forecast of the target, and the features may refer to attributes of structured data in a data repository related to the target influence variables.

And the server computing system 130 may filter related features associated with the target influence variables among features of the data store, and may integrate the filtered features to generate structured data or a structured dataset.

Specifically, in describing a process of generating the structured data or dataset, the server computing system 130 may first list available features from the data store by feature name. And a description for each feature may be listed together.

In this case, the server computing system 130 may refine the description using the LLM to perform embedding. Accordingly, during embedding, important content in the descriptions of the features may be better captured.

And the server computing system 130 may filter, among the listed features, the features related to the target influence variables that may affect the target, based on association to the target influence variables defined at the semantic level.

To this end, the server computing system 130 may utilize the machine learning model or the language model that classifies the relevance between the features and the target influence variables.

In an embodiment, the server computing system 130 may list the feature name and the description of the data store, input the keyword of the target influence variables of the causal information into a word embedding model, and map features classified into each target influence variable by detecting feature names associated with the keyword of each target influence variable according to feature relevance. Here, word embedding refers to a method of representing words as vectors by classifying features that are relevant to semantic target influence variables based on the feature names and the descriptions.

And the server computing system 130 may retrieve structured data (tabular data) corresponding to the names of the classified features from the data store, and process the retrieved structured data through data cleaning and preprocessing and arrangement into a structured format to make the data suitable for input into target prediction modeling, thereby generating the data in a time-series structured data format (e.g., csv, excel, etc.). As such, the server computing system 130 may collect accurate raw data serving as the basis for target prediction based on the causal information between the target and the target influence variables, and may precisely filter structured data and unstructured data required for target prediction from the collected raw data, thereby utilizing the data as input data for target prediction modeling.

In operation S107, the server computing system 130 may quantify the unstructured data to generate quantitative data. For example, the server computing system 130 may generate the quantitative data by quantifying the unstructured data through text processing for prediction.

First, the server computing system 130 may generate prediction scoring data by scoring on target prediction values (prospect scoring) for each target forecast report that predicts the forecast of the target among documents classified as the unstructured data.

In detail, in an embodiment, the server computing system 130 may input each target forecast report into the language model and cause the language model to operate according to a target forecast scoring prompt that performs sentiment analysis on related sentences classified as predicting the forecast of the target so as to classify the forecast of the target into positive, neutral, and negative, and to quantify and return a level of tone, thereby enabling the server computing system 130 to generate quantitative data by listing the prediction scoring data in a time order.

Specifically, the target forecast scoring prompt to be returned may be configured such that, when the target forecast report (or a related sentence regarding the target forecast that is pre-extracted from the target forecast report) is input, an opinion on the target forecast is classified into positive/neutral/negative from the input text, and a tone of the forecast opinion is selected from the input text within a predetermined level range.

In addition, the server computing system 130 may generate an event list based on related events affecting the forecast of the target detected from documents during unstructured data filtering.

For example, the server computing system 130 may generate, as quantitative data, an event list that quantifies an occurrence date of an event affecting the forecast of the target, a related feature, a value of the related feature, and an impact and influence affecting the forecast of the target.

In addition, the server computing system 130 may encode each document classified as the unstructured data into latent vectors through an encoder of the language model to return an embedding matrix. Specifically, the server computing system 130 may obtain the embedding matrix capturing the semantic essence of each document by encoding the document into latent vectors using the language model.

In detail, the server computing system 130 may input documents such as news articles among the unstructured data into the encoder of the language model to generate a document embedding matrix for modeling widespread topics in each document. The document embedding generated in this manner may emphasize topics (variables or features) that may affect a future forecast of the target by identifying the widespread topics in the documents using an algorithm such as latent Dirichlet allocation (LDA).

In operation S109, the server computing system 130 may predict the target forecast based on the generated structured dataset and the quantitative data.

In detail, the server computing system 130 may calculate forecast values of the target for each prediction unit time for the total prediction length based on the quantitative data, the structured dataset, and the like.

To this end, the server computing system 130 may generate an integrated structured dataset by concatenating the structured dataset generated based on the structured data with the quantitative dataset generated based on the unstructured data.

Specifically, the server computing system 130 may first classify the data according to influence on the target, and concatenate the data by assigning weights.

For example, the server computing system 130 may classify, among features included in the structured dataset, variables that affect the target above a reference value into macro variables, and classify variables that affect the target below the reference value into micro variables.

And the server computing system 130 may match the classified macro variables with the quantitative data in a time series, integrate them into a single macro time-series structured dataset, and integrate the data classified into the micro variables into the single micro time-series structured dataset.

That is, in an embodiment, the server computing system 130 may generate the integrated structured dataset including both information of the structured data and information of the unstructured data by matching and concatenating the event list and the prediction scoring data according to a time-series flow of the structured dataset.

And the server computing system 130 may input the generated integrated structured dataset into the prediction model to calculate the forecast values of the target for each prediction unit time for the total prediction length. Here, the prediction model may include linear regression, decision tree, random forest, gradient boosting, deep learning models, and/or pre-trained language models.

In an embodiment, the server computing system 130 may additionally input the causal information at the semantic level into the prediction model to induce the prediction of the target forecast according to the causal information. In addition, in an embodiment, the server computing system 130 may input the embedding matrix described above into a second prediction model that predicts the target forecast based on the embedding matrix, so that unstructured target prediction information not included in the structured data may be reflected in the predicted value.

Specifically, in an embodiment, the server computing system 130 may input the integrated structured dataset into a first prediction model to primarily calculate a first target forecast value. And the server computing system 130 may regulate the first target forecast value based on the semantic causal graph to calculate a second target forecast value in which the causal information between the target influence variables and the target is reflected.

Finally, the server computing system 130 may calibrate the calculated second target prediction value based on unstructured target prediction information, and may finally calculate a final target forecast value.

In operation S111, the server computing system 130 may interpret grounds for the target forecast based on the causal information and the structured dataset to generate ground information.

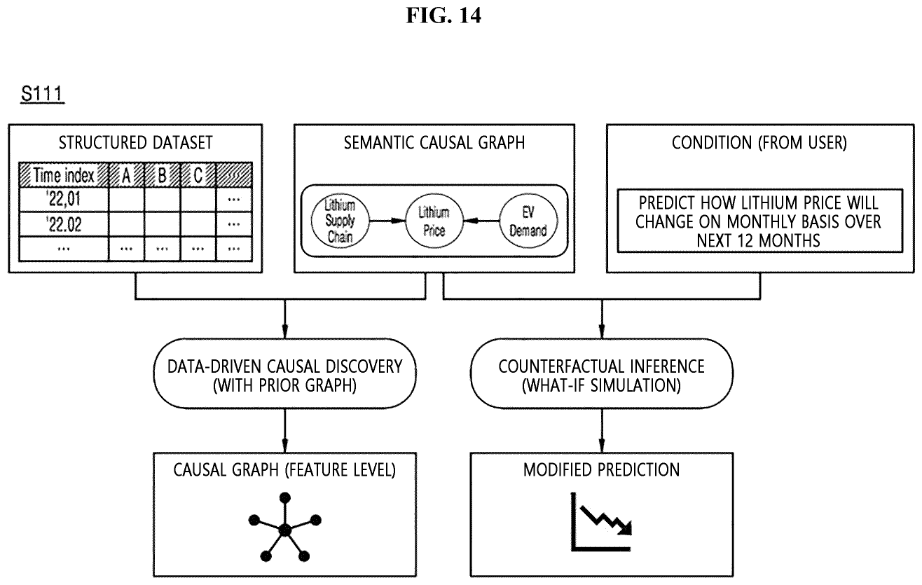

Referring to FIG. 14, the server computing system 130 may output ground information by interpreting grounds for the final target forecast value based on the causal information at the semantic level and the structured dataset.

Specifically, the server computing system 130 may generate a past causal graph at a feature level based on past existing target values relative to the present from the structured dataset, the structured dataset, and the semantic causal graph.

And the server computing system 130 may generate a future causal graph at the feature level based on a future final target forecast values relative to the present, the structured dataset, and a causal discovery model (data-driven causal discovery) trained based on the semantic causal graph with the past causal graph.

And the server computing system 130 may provide the future causal graph mapped to the target forecast value, thereby providing, as ground information, which features have influenced the target forecast value and to what extent, so that the target forecast value has been derived.

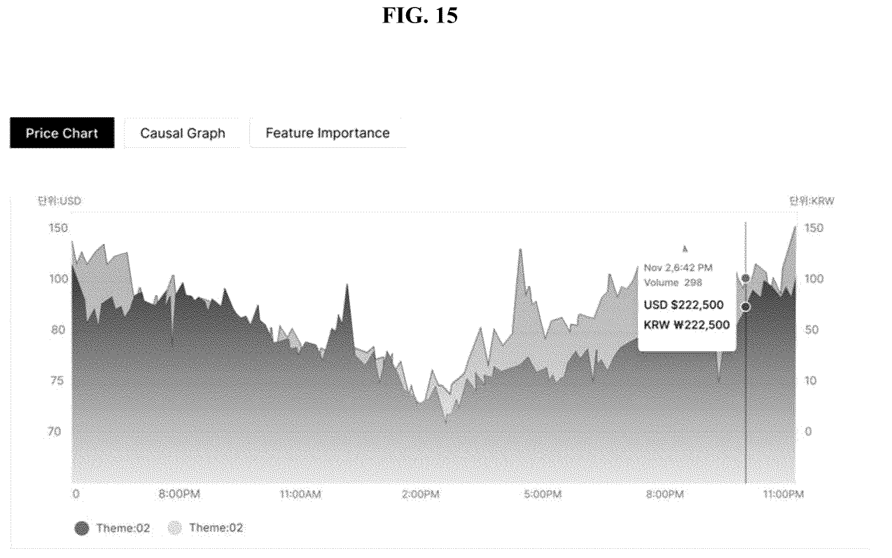

FIG. 15 is an exemplary diagram of a chart for the predicted target forecast according to an embodiment of the invention.

Referring to FIG. 15, the server computing system 130 may provide a target forecast graph representing the target forecast values calculated for each prediction unit time for the total prediction length through the user computing device 110.

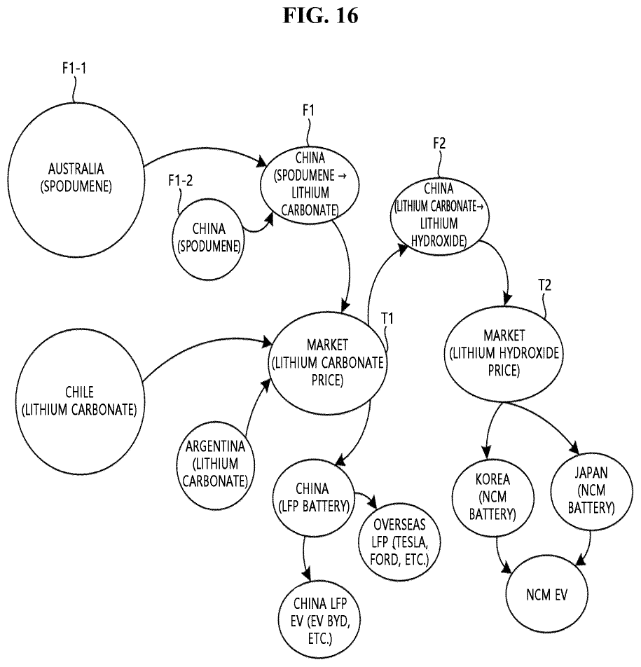

FIG. 16 is an example of a causal graph presented as ground data of the predicted target forecast according to an embodiment of the invention.

Referring to FIG. 16, the server computing system 130 may provide, as ground information, a causal graph at a feature level interpreting grounds for the target prediction values, through the user computing device 110.

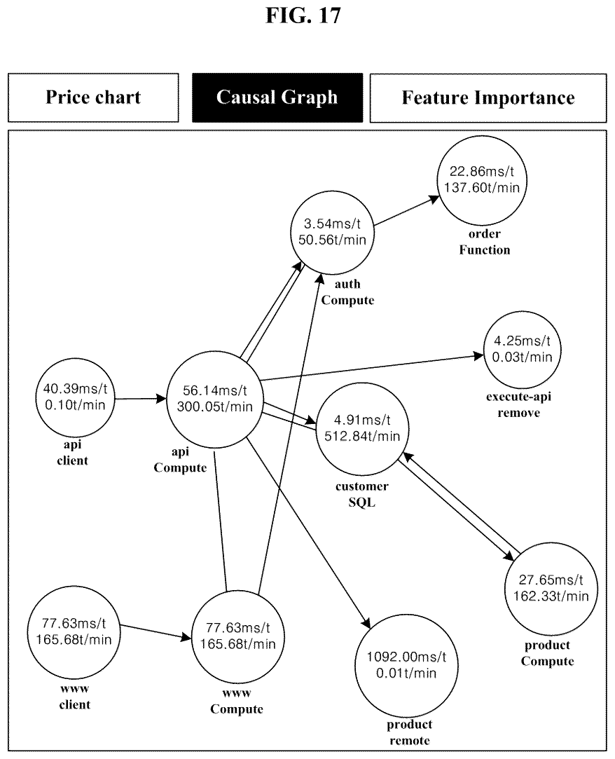

FIG. 17 is another example of a causal graph presented as ground data for the predicted target forecast according to an embodiment of the invention.

Referring to FIG. 17, may further enhance user reliability in the target forecast by displaying, together with the predicted target forecast value, specific values of features that have affected the predicted target forecast at a specific prediction point.

As such, the server computing system 130 may output and provide, as a result, the final target forecast value and the ground information that are derived for the target according to a target prediction request.

In addition, the server computing system 130 may receive a what-if scenario (what-if) from a user and perform a simulation for the input what-if scenario, thereby predicting a what-if target forecast.

In operation S113, when receiving an input of a what-if scenario that changes a prediction environment from the user, the server computing system 130 may predict a what-if target forecast by performing again a simulation for predicting the target forecast for the target prediction request according to the input what-if scenario and providing again the target forecast values and the ground information in the changed environment (i.e., the what-if scenario). Specifically, referring to FIG. 14, the user may input a change of a prediction environment by changing the target influence variable (hereinafter, a target value) that affects the target forecast value or by inputting occurrence of a specific event (hereinafter, an event value) through the user computing device 110.

For example, for a target prediction request such as “Predict how the lithium price will change on a monthly basis over the next 12 months,” changing the target value may mean changing “lithium” to lithium carbonate and/or lithium hydroxide, and changing the event value may mean adding an event such as a war situation, a supply-demand situation, and the like.

In an embodiment, when there is a change in the target influence variable, the server computing system 130 may change the integrated structured dataset according to the changed target influence variable, and may output and provide the target forecast values and ground information according to a simulation that re-executes a process of forecasting the target forecast values and interpreting the grounds to the user computing device 110.

Hereinafter, for convenience of description, a target forecast predicted in a state in which no what-if scenario is reflected will be referred to as a “general result (or target forecast),” and a target forecast predicted in a state in which a what-if scenario is reflected will be referred to as a “what-if result (or target forecast).” In addition, predicting the what-if target forecast by reflecting the change in the target influence variables is referred to as a “what-if simulation.”

In addition, in an embodiment, since the what-if simulation is a process based on operations S101 to S111, only differences therefrom will be mainly described.

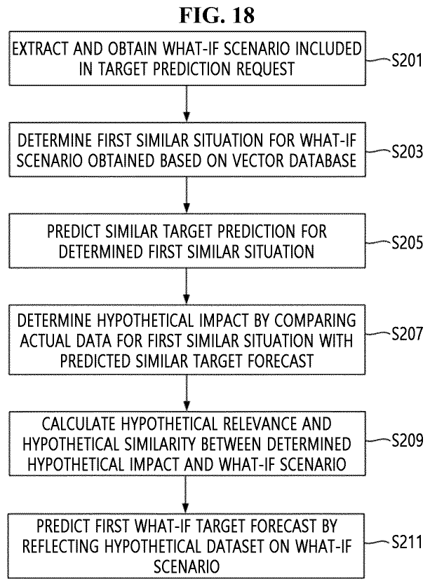

FIG. 18 is a flowchart of a method of performing the what-if simulation according to an embodiment of the invention.

Referring to FIG. 18, in operation S201, the server computing system 130 may extract and obtain the what-if scenario included in the target prediction request according to receiving the target prediction request including the what-if scenario.

For example, when the existing target prediction request without reflecting the what-if scenario was “Predict how the lithium price will change on a monthly basis over the next 12 months,” the target prediction request reflecting the what-if scenario may be input as “Predict how the lithium price will change on a monthly basis over the next 12 months in the event of outbreak of a China-Taiwan war.”

That is, in the above example, occurrence of a specific event, i.e., “outbreak of a China-Taiwan war,” may be extracted as the what-if scenario.

In addition, the server computing system 130 may perform counterfactual inference the what-if target forecast through a what-if simulation to predict. Throughout the invention, the counterfactual inference may also be referred to as subjunctive inference.

Here, the counterfactual inference refers to predicting how a result would be derived when a situation is assumed in the form of a scenario. Such counterfactual inference may be utilized to specify a path and remove causal effects in order to reduce recommendation bias with respect to the existing target forecast.

To this end, the server computing system 130 may derive a first what-if result, which is a counterfactual result when the what-if scenario exists, based on an input of a specific path referred to as the what-if scenario, and a first general result, which is a factual result when the what-if scenario does not exist. For example, when the what-if scenario of “when a China-Taiwan war occurs” is additionally input to text of the target prediction request of “Predict how the lithium price will change on a monthly basis over the next 12 months,” the server computing system 130 may derive the first what-if result, which is the counterfactual result when the China-Taiwan war occurs, and the first general result, which is the factual result when the China-Taiwan war does not occur.

That is, the server computing system 130 may simulate how the what-if result changes compared with the general result through counterfactual inference when an artificial intervention is applied to the observed data distribution.

In other words, the server computing system 130 may derive the first what-if result by setting a first what-if target to derive the counterfactual result according to the what-if scenario based on the counterfactual inference.

Here, since deriving the first general result is the same as operations S101 to S111, it will be omitted by applying the same, and only a process of deriving the first what-if result will be described below.

In operation S203, the server computing system 130 may determine a first similar situation for the what-if scenario obtained based on a vector database. In an embodiment, the server computing system 130 may analyze text of the obtained what-if scenario and perform a target prediction task, thereby determining a target prediction element. In addition, the server computing system 130 may retrieve at least one similar situation in which similarity to the target and the target influence variables of the first what-if target is equal to or greater than a predetermined reference (value) through a search in the data store (as an embodiment, the vector database) based on the determined target prediction element In addition, the server computing system 130 may extract and determine the first similar situation having the highest similarity among the at least one retrieved similar situation. That is, the determined first similar situation may be a situation most similar to the what-if scenario among situations (e.g., news articles) retrieved from the data store.

In operation S205, the server computing system 130 may predict a similar target forecast for the determined first similar situation. In an embodiment, the server computing system 130 may retrieve attributes (e.g., a time point and/or another related target) of the first similar situation through the large language model (LLM) and/or data tagging, and may predict the similar target forecast for the first similar situation based on the retrieved contents. In this case, the server computing system 130 may predict the similar target forecast by collecting the latest information relative to a time point of the first similar situation using the RAG model. Accordingly, a hypothetical past according to the time point of the first similar situation may be determined.

In operation S207, the server computing system 130 may determine a hypothetical impact by comparing actual data for the first similar situation with the predicted similar target forecast.

In operation S209, the server computing system 130 may calculate a hypothetical relevance and a hypothetical similarity between the determined hypothetical impact and the what-if scenario. In an embodiment, the hypothetical relevance may be calculated and determined through the LLM as to how relevant the hypothetical impact is to the what-if scenario. Similarly, the hypothetical similarity may be calculated and determined through the LLM as to how similar the hypothetical impact is to the what-if scenario.

In operation S211, the server computing system 130 may predict a first what-if target forecast (or first what-if result) by reflecting the hypothetical impact, the hypothetical relevance, and the hypothetical similarity (hereinafter, a hypothetical dataset) on the what-if scenario based on the current time point.

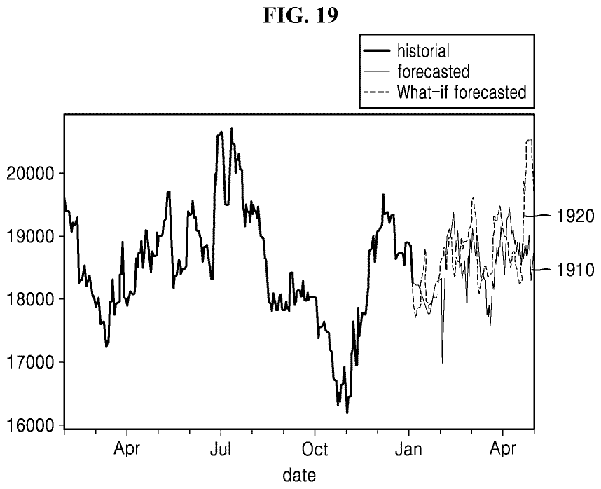

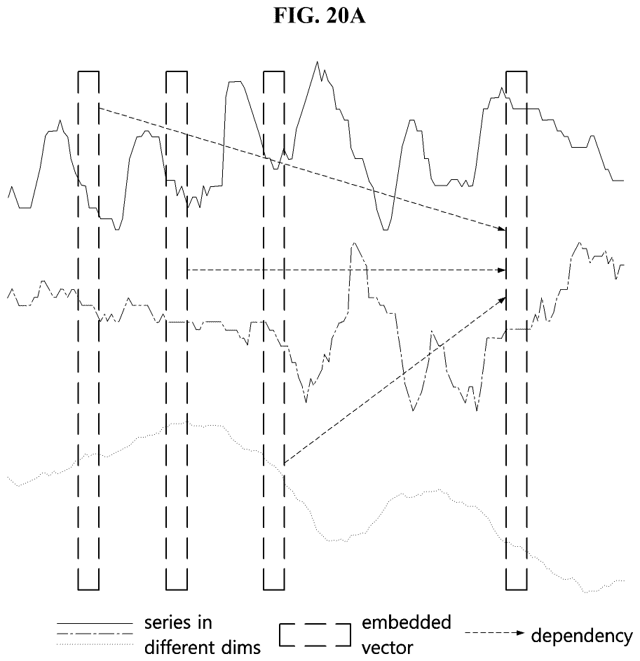

FIG. 19 is a graph related to the general result and the what-if result according to an embodiment of the invention.

Referring to FIG. 19, the server computing system 130 may compare and analyze a first general result 1910 and a first what-if result 1920 that are derived, and provide the user with a difference between the two results as visualized data. In another embodiment, the server computing system 130 may receive an input of a prediction environment change according to occurrence of a specific event. In this case, when the occurrence of the specific event can be quantitatively reflected in the event list, the server computing system 130 may derive changed quantitative data, modify again the integrated structured dataset based on the changed quantitative data, and re-execute the process of interpreting the target forecast values and grounds, thereby outputting the target forecast values and ground information according to the what-if simulation and providing the same to the user computing device 110.

The artificial intelligence prediction model according to an embodiment may additionally be trained according to an efficient segment-based sparse transformer (ESSformer) method in order to capture both long-term temporal dependencies and dependencies between features of different variables. Hereinafter, this will be described.

Time-series forecasting is a fundamental machine learning task aimed at predicting future events based on past observations. Such a prediction problem often requires long-term prediction and may involve multiple variables. For example, stock price prediction may require predicting multiple market values over a long temporal axis. In such a multivariate long-term time-series forecasting (M-LTSF) problem, it is important to capture both long-term temporal dependencies between past and future events and dependencies between features of different variables.

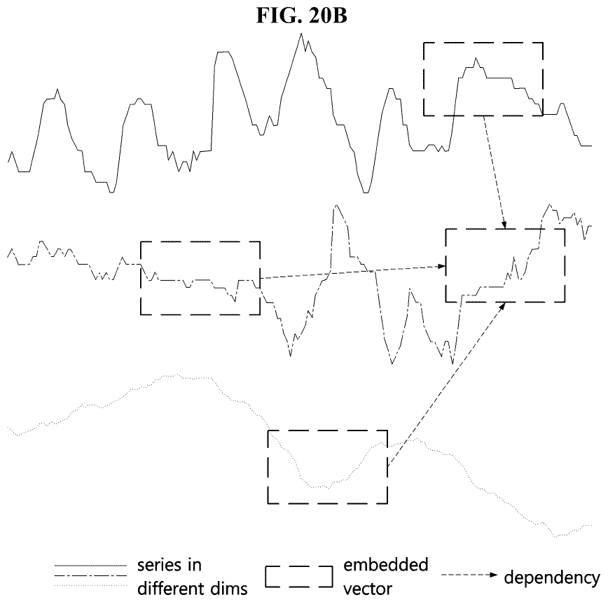

In recent years, many deep neural architectures such as a linear model, a state-space model, and a recurrent neural network (RNN) have been developed for the M-LTSF problem. Among them, a transformer model is a neural network that learns context and semantics by tracking relationships in sequential data such as words in a sentence and has demonstrated remarkable performance in various domains such as language and image processing, and due to its ability to capture long-term relationships, the transformer model has also been studied in the field of the M-LTSF. For example, as shown in FIG. 20a, a transformer model in which one observation is treated as one token have been used in the field of time-series forecasting. In recent studies, as shown in FIG. 20b, a segment-based transformer model, in which each token is represented as a group of consecutive observations rather than a single observation, has been proposed. However, in the case of self-attention of the segment-based transformer model, one segment is treated as one token, and as the segment becomes more segmented, the prediction performance improves, but when it is segmented, the number of tokens greatly increases, thereby significantly increasing the computational cost of attention. In addition, as shown in FIG. 20b, in inter-feature attention that finds associations between features, when the number of features is very large, prediction may be performed quite inefficiently. In order to address these problems, an embodiment of the invention is directed to providing a time-series forecasting method that maintains performance while being less segmented and that also maintains performance even in inter-feature attention in which the number of features is large.

The transformer model provided by an embodiment of the invention may be referred to as an efficient segment-based sparse transformer (ESSformer).

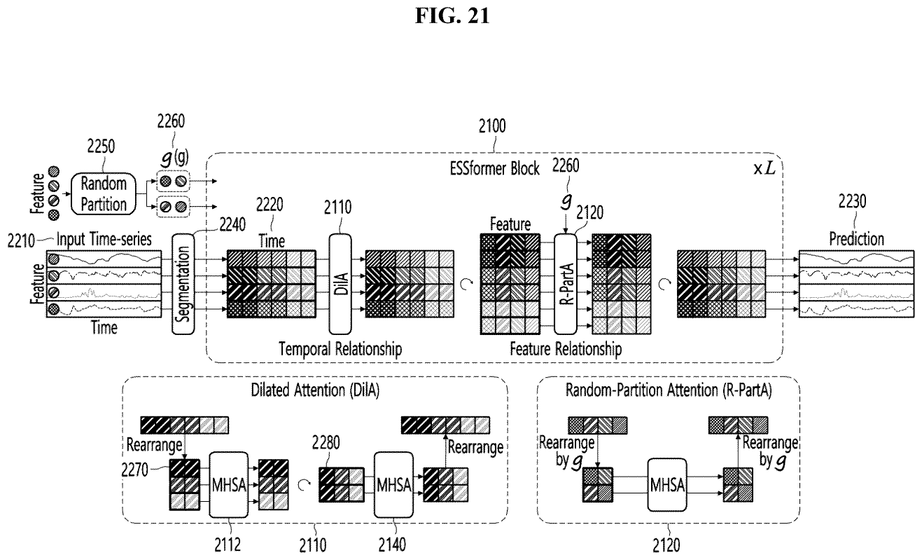

FIG. 21 is a schematic diagram of an ESSformer block according to an embodiment of the invention.

Referring to FIG. 21, a dimension-segment-wise (DSW) embedding may be performed in order to process past time-series information. In the DSW embedding, each dimensional series may be partitioned into segments and then embedded into feature vectors.

An output of the DSW embedding may be a 2D vector matrix having time and dimension as two axes. In order to efficiently capture cross-temporal and cross-dimensional dependencies between such vector matrices, two stages of attention layers may be used.

In an embodiment, the ESSformer block 2100 may include sparse attention modules customized for the segment-based transformer. In an embodiment, the ESSformer may include a dilated attention (DilA) module 2110, which learns interactions among periodically distant segments to efficiently capture temporal dependencies and a random-partition attention (R-PartA) module 2120, which captures inter-feature dependencies. The DilA module 2110 may be an attention module in a time dimension, and the R-PartA module 2120 may be an attention module in a feature dimension. That is, the DilA module 2110 may be a model that efficiently learns temporal dependencies, and the R-PartA module 2120 may be a model that efficiently learns inter-feature dependencies.

Hereinafter, the ESSformer block 2100 will be described in more detail using equations. In an embodiment, the DilA module 2110 may be designed by configuring dilated attention with a stride P and configuring block-diagonal attention with a block size P based on the fact that periodic patterns appear in a self-attention matrix of the segment-based transformer. Through this, when the number of segments N_{S} is given as an input, the computational cost in the temporal attention layer may be reduced from

$$𝒪 ( {N}_{S}^{2} ) to 𝒪 ( {N}_{S}^{1.5} ) .$$

In an embodiment, the R-PartA module 2120 may be designed by randomly partitioning features into groups of the same size S_{G} and masking attention matrices between different groups, in order to capture dependencies among various features. Through this design, when the feature size is D, the attention computation cost may be reduced from O(D²) to O(DS_{G}). According to an embodiment, the stochasticity inherent in the random partition of the R-PartA module 2120 may enable efficient and effective learning. In addition, according to an embodiment, the limitation that inter-feature relationships cannot be fully captured from the masked attention may be addressed using a test-time ensemble technique in the inference stage.

In an embodiment, a D-variable time-series observation xₜ at time t may be represented as {x_{t,d}∈ [symbol] |d∈[0:D]}∈ [symbol] ^{D}, where x_{t,d} denotes an actual observed value of a d-th feature at time t. The goal of time-series forecasting may be to predict future observations {xₜ}_{t∈[T, T+τ]} based on previous observations {xₜ}_{t∈[0, T]}. Here, T denotes the length of past time steps, and τ denotes the length of future time steps. An embodiment of the invention is directed to providing an efficient time-series forecasting method in cases of multivariate long-term time-series forecasting, where D>1 and τ>>1.

In an embodiment, multivariate time-series observations {x_{t,d}}_{t∈[0:T], d∈[0:D]} may be divided into N_{S} segments of the same length. That is, the b-th segment of the d-th feature may be represented as [Equation 11] below.

$${s}_{b , d} = \{ {x}_{t , d} ∈ ℝ \vert t ∈ [ \frac{b T}{{N}_{S}} : \frac{( b + 1 ) T}{{N}_{S}} ] \} ∈ {ℝ}^{\frac{T}{{N}_{S}}} \qquad [ Equation 11 ]$$

In an embodiment, observations may be embedded into a latent space through a linear layer, and trainable temporal encoding E^{Time}∈ [symbol] ^{N}^{ₛ}^{×d}^{ₕ} and feature-specific positional encoding E^{Feat}∈ [symbol] ^{D×d}^{ₕ} may be added, thereby representing the input as [Equation 12] below.

$${H}_{b , d}^{( 0 )} = Linear ( {s}_{b , d} ) + {E}_{b}^{Time} + {E}_{d}^{Feat} ∈ {ℝ}^{{d}_{h}} , {H}^{( 0 )} ∈ {ℝ}^{{N}_{S} \times D \times {d}_{h}} . \qquad [ Equation 12 ]$$

When an initial representation H⁽⁰⁾ is given as input, a segment-based transformer encoder having L layers may output a final representation H^{(L)}, and the output H^{(L)} may be delivered through a decoder to predict future observations.

In an embodiment, by using a linear-based decoder,

$${\{ {H}_{b , d}^{( L )} \}}_{b = 1}^{{N}_{S}}$$

may be mapped to future observation {x_{t,d}}_{t∈[T, T+τ]} by a single linear layer.

Hereinafter, based on the above representations, the ESSformer according to an embodiment of the invention will be described. In an embodiment, when an input segment representation H⁽⁰⁾ is given, each layer of the ESSformer may be represented as [Equation 13] and [Equation 14] below.

$${\overline{H}}^{( ℓ - 1 )} = {H}^{( ℓ - 1 )} + R - Part A ( {H}^{( ℓ - 1 )} , Dil A ( {H}^{( ℓ - 1 )} ) ) \qquad [ Equation 13 ]$$

$${H}^{( ℓ )} = {\overline{H}}^{( ℓ - 1 )} + M L P ( {\overline{H}}^{( ℓ - 1 )} ) , ℓ = 1 , ... , L \qquad [ Equation 14 ]$$

Hereinafter, the DilA module 2110 will be described. In an embodiment, in order to capture temporal relationships from input segments H∈ [symbol] ^{N}^{ₛ}^{×D×d}^{ₕ}, the DilA module 2110 processes the input through two attention modules 2112 and 2114, each of which may discover separate temporal relations. In an embodiment, the attention modules 2112 and 2114 may be multi-head self-attention (MHSA) modules. For intra-period relationships, the block-diagonal attention module 2112 having the block size P may mix features among segments in the same time period. For inter-period relationships, the dilated attention module 2114 having stride P may share representations among periodically distant segments for longer-range contextualization.

Here, Q, K, and V denote query, key, and value, respectively, and MHSA(Q, K, V) is assumed to represent a vanilla MHSA layer. When a set of integers C is given as an index, it may denote selecting all indices included in C (e.g., [symbol] _{,d}= [symbol] ∈ [symbol] ^{|} [symbol] ^{|×d}^{ₕ}). In this case, the step-by-step procedure of the DilA module 2110 may be represented as [Equation 15] and [Equation 16] below.

$$∀ i ∈ [ 0 : \frac{T}{P} ] , {{\tilde{V}}^{Dil A} ( H )}_{[ iP : ( i + 1 ) P ] , d} = M H S A ( {H}_{[ iP : ( i + 1 ) P ] , d} , {H}_{[ iP : ( i + 1 ) P ] , d} , {H}_{[ iP : ( i + 1 ) P ] , d} ) \qquad [ Equation 15 ]$$

$$∀ j ∈ [ 0 : P ] , Dil {A ( H )}_{[ j \text{::} P ] , d} = M H S A ( {H}_{[ j \text{::} P ] , d} , {H}_{[ j \text{::} P ] , d} , {{\tilde{V}}^{Dil A} ( H )}_{[ j \text{::} P ] , d} ) \qquad [ Equation 16 ]$$

Here, [j::P] denotes an index set starting from j with stride P. That is, [j::P] {j, j+P, j+2P, . . . }. In an embodiment, the block-diagonal attention module may capture the intra-period relationships through [Equation 15], and the inter-period relationships may be considered through [Equation 16].

When the DilA module 2110 is not used, the computational cost of

$$𝒪 ( {N}_{S}^{2} )$$

is required in order to encode N_{S} segments through self-attention. This may become difficult to handle when considering time-series data with large T. Although expanding the duration of each segment may reduce N_{S}, in transformer-based generative modeling, the lower the granularity of the segments, the lower the inference quality. Accordingly, considering that time-series forecasting is similar to generating future observations conditioned on past signals, an efficient architecture with quadratic asymptotic cost in terms of the number of segments is required. To address this limitation, the DilA module 2110 according to an embodiment may effectively impose block-diagonal and stride sparse attention masks, thereby reducing the computational cost without significantly sacrificing the expressiveness of self-attention.

In an embodiment, sparse attention refers to attention that reduces computational complexity by adding a sparsity bias to the attention, based on the concept that a matrix filled with many non-zero elements is called a dense matrix and a matrix with many zeros is called a sparse matrix, and may include position-based sparse attention, content-based sparse attention, and the like.

A periodically dilated sparse structure according to an embodiment was proposed, inspired by graphs depicting attention score matrices of various transformer models after training on the M-LTSF. In an embodiment, since the period is

$${P}_{*} = - {2}^{⌈ {log}_{2} \sqrt{{N}_{S}} ⌉} \approx \sqrt{{N}_{S}} ,$$

time and memory complexity may be reduced from

$$𝒪 ( {N}_{S}^{2} ) to 𝒪 ( {N}_{S}^{1.5} ) .$$

Periodically sparse attention using P* may be sufficient to maintain the downstream functionality of full attention.

Hereinafter, the R-PartA module 2120 will be described. A segment-based transformer for M-LTSF may tokenize each feature individually and, in addition to temporal contextualization, model interactions among features, thereby enhancing downstream performance. However, this is the full attention, which requires a computational cost of O(D²), and accordingly, it may be difficult to handle a large number (D) of features. In an embodiment, in order to reduce the cost for D, the R-PartA module 2120 may first randomly partition D features into N_{G} separate groups { [symbol] (g)}_{g∈[0:N}_{_{G}}_{]}. Here, the separate groups may all have the same size S_{G}, where may be | [symbol] (g)|=S_{G}, ∩_{g∈[0:N}_{_{G}}_{]} [symbol] (g)=φ; and ∪_{g∈[0:N}_{_{G}}_{]} [symbol] (g)=[0:D]). In an embodiment, a single partition may be sampled before each forward step and used across the entire layers of the transformer model. Then, the R-PartA module 2120 may mix representations among features in the same group through the block-diagonal attention according to [Equation 17].

$$\text{∀ℊ} ∈ [ 0 : {N}_{G} ] , R - Part {A ( H , V )}_{b , 𝒢 ( ℊ )} = M H S A ( {H}_{b , 𝒢 ( ℊ )} , {H}_{b , 𝒢 ( ℊ )} , {V}_{b , 𝒢 ( ℊ )} ) \qquad [ Equation 17 ]$$

Since this operation considers only intra-group interactions, the computational cost may be reduced from O(D²) to O(DS_{G}). However, if the prediction procedure is executed only once in the inference stage, only partial inter-feature information in each group may be considered. To address the limitation that the entire information is not utilized, the test-time ensemble method may randomly partition N_{E} times, execute the prediction procedure, and ensemble (e.g., average) prediction outputs of N_{E}. The ensemble procedure may be performed according to [Algorithm 2] below.

Algorithm 2
Algorithm 1: Training & inference of ESSformer

```
Input: # of features D, # of layers L, # of groups N_{G}, # of test-time
    ensembling N_{E}, Length of a period in [symbol]  -th layer P [symbol] , Past
    $observations X = {\{ {X}_{d} \}}_{d = 1}^{D}$
N_{E} = N_{E} if is inference then else 1;
F = [0 : D];
for i ← 1 to N_{E} do
```

| \| | [symbol] = ( [symbol] (g))gϵ[0:N_{G}] = Random_Partition(F); | |
|---|---|---|
| \| | H⁽⁰⁾ = Segmentation(X); | |
| \| | for [symbol] ← 1 to L do | |
| \| | └ | H⁽ [symbol] ⁾ = ESSformer-Layer⁽ [symbol] ⁾ (H⁽ [symbol] ⁻¹⁾, P [symbol] , G); |

| | |
|---|---|
| \| | ${Y}_{d}^{i} = Linear ( Concat ( \{ {H}_{b , d}^{( L )} \} {b}_{ϵ [ 0 : {N}_{S} ]} ) ) ;$ |
| └ | ${Y}^{i} = \{ {Y}_{d}^{i} \} d ∈ [ 0 : D ]$ |

Y = (Y¹ + Y² + ... + Y^{N}^{_{E}}) /N_{E};
return Predicted future observations Y;

According to an embodiment of the invention, not only may the computational cost be reduced through the R-PartA module 2120, but also the prediction performance may be improved.

In the description referring to FIG. 21, the ESSformer block 2100 was described as an example in which both the DilA module 2110 and the R-PartA module 2120 are used, but it is apparent that only one of the DilA module 2110 and the R-PartA module 2120 may be used.

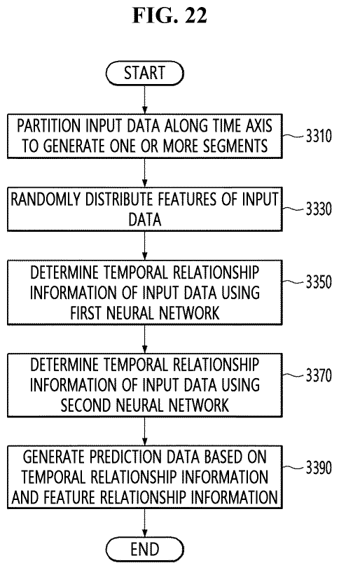

FIG. 22 is a flowchart illustrating a prediction data generation method according to an embodiment of the invention.

Referring to FIG. 22, in operation 3310, the prediction data generation method may include an operation of partitioning input data along a time axis to generate one or more segments. In an embodiment, the input data may include the input time-series data 2210 in the example of FIG. 21. The input time-series data 2210 may be multivariate time-series data. Such input data may be segmented along the time axis to generate an input sequence or input segments 2220. Accordingly, a system for generating prediction data may include a segmentation module 2240 for partitioning input data along the time axis to generate one or more segments. The ESSformer block 2100 according to an embodiment of the invention may include a neural network for generating prediction data 2230 using the input sequence 2220. The segmentation module 2240 may be located outside the ESSformer block 2100 as shown in FIG. 21, or may be located inside the ESSformer block 2100.

In operation 3330, the prediction data generation method may include an operation of randomly distributing features of the input data. In FIG. 22, operation 3330 is illustrated as being located between operation 3310 and operation 3350, but this is merely an example, and operation 3330 may be performed in any order as long as it is before operation 3370. For example, operation 3330 may be also performed before operation 3310, or may be performed between operation 3350 and operation 3370.

In an embodiment, the system may include a random partition module 2250 for randomly distributing features of the input data. In an embodiment, partition information 2260 of the features partitioned by the random partition module 2250 may be used when a second neural network for extracting dependencies among features is used.

In an embodiment, the random partition module 2250 may be located outside the ESSformer block 2100 as shown in FIG. 21, or may be located inside the ESSformer block 2100. For example, when the random partition module 2250 and the segmentation module 2240 are located outside the ESSformer block 2100, the ESSformer block 2100 may receive the partition information 2260 of the features and the segmented input sequence 2220 as inputs and may use the inputs to generate the prediction data 2230.

In operation 3350, the prediction data generation method may include an operation of determining temporal relationship information of the input data using a first neural network. The first neural network may include a neural network that applies dilated attention to the input sequence segmented along the time axis.

In an embodiment, at least one processor performing the prediction data generation method may rearrange the segmented input sequence based on a predetermined period and may perform multi-head self-attention (MHSA) on the rearranged data. Here, the predetermined period may be

For example, when there are six segments as illustrated in FIG. 21, the description will be given with segment #0, segment #1, . . . , segment #5 sequentially numbered from the beginning. In this case, the predetermined period may be \sqrt{6}≈2.44≈2. Accordingly, at least one processor may rearrange the input sequence by segmenting it for each period. Accordingly, first rearranged data 2270 may be rearranged as {segment #0, segment #1}, {segment #2, segment #3}, {segment #4, segment #5}. First MHSA 2112 may be applied to the first rearranged data to extract dependencies along the time axis. However, in this case, since it may be difficult to capture the dependencies between distant segments, at least one processor may rearrange the input sequence by grouping segments that are apart by the period. Accordingly, second rearranged data 2280 may be rearranged as {segment #0, segment #2, segment #4}, {segment #1, segment #3, segment #5}. At least one processor may identify the dependencies among the segments that are apart by the period using second MHSA 2114 for the second rearranged data 2280. That is, the first neural network may include the MHSA module 2112 for extracting features among segments in the same time period, and the second MHSA module 2114 for extracting features among periods of segments that are periodically apart, based on rearrangement of the input sequence segmented along the time axis for each feature.

In an embodiment, the temporal relationship information of the input data may be determined by the first neural network. According to an embodiment, not all temporal dependencies among all segments are extracted, but only the temporal dependencies among segments in a period and the temporal dependencies among segments that are apart by the period are extracted, while prediction performance is maintained. That is, according to an embodiment, the dependencies among consecutive segments and the dependencies among segments that are apart by a predetermined period may be extracted, thereby reducing computational complexity while maintaining prediction performance.

In operation 3370, the prediction data generation method may include an operation of determining feature relationship information of the input data using the second neural network. In an embodiment, the second neural network may include a neural network that applies random partition attention to data arranged along a feature axis. The second neural network may use data in which the output data of the first neural network are arranged along the feature axis, or may use data in which the segmented input sequence is arranged along the feature axis.

In an embodiment, the second neural network may include a third MHSA module 2290 for extracting dependencies among features based on rearrangement of features of the input data according to the partition information 2260 determined by the random partition module 2250. For example, when there are four features in total, namely feature #1, feature #2, feature #3, and feature #4 in order from the top, and the partition information 2260 as illustrated in FIG. 22 is {feature #4, feature #2} and {feature #3, feature #1}, at least one processor may generate third rearranged data by rearranging each piece of data arranged along the feature axis into {feature #4, feature #2} and {feature #3, feature #1}. In addition, the at least one processor may apply the MHSA to the third rearranged data, and rearrange it again based on the partition information 2260 to restore the order of the features. Through this, the at least one processor may determine feature relationship information of the input data using the second neural network.

In operation 3390, the prediction data generation method may include an operation of generating prediction data based on the temporal relationship information and the feature relationship information. In an embodiment, the prediction data may be generated based on the temporal relationship information determined by using the first neural network and the feature relationship information determined by using the second neural network. That is, at least one processor may generate the prediction data by processing the input sequence segmented along the time axis using the neural networks.

In an embodiment, at least one of the first neural network and the second neural network may include the sparse attention module.

[Table 2] is a table illustrating performance of the ESSformer block according to an embodiment of the invention.

TABLE 2

| | | Segment- | | | Observation- | | | | | | | | |
|---|---|---|---|---|---|---|---|---|---|---|---|---|---|
| | | based Transformer | | | based Transformer | | | Linear | | | Others | | |
| | | ESS- | Cross- | Patch- | [symbol] ED- | Pyra- | In- | TS- | NLin- | NLin- | | Times- | Deep- |
| Data | | former | former | TST | former | former | former | Mixer | ear | ear-m | MICN | Net | Time |
| ETTh1 | [symbol] = 96 | 0.361 | 0.427 | 0.370 | 0.376 | 0.664 | 0.941 | 0.361 | 0.374 | 0.463 | [symbol] | 0.465 | 0.372 |
| | 192 | 0.396 | 0.537 | 0.413 | 0.423 | 0.790 | 1.007 | 0.404 | 0.405 | 0.535 | 0.765 | 0.493 | 0.405 |
| | 336 | 0.400 | 0.651 | 0.422 | 0.444 | 0.891 | 1.038 | 0.420 | 0.429 | 0.531 | [symbol] | 0.456 | 0.437 |
| | 720 | 0.412 | 0.664 | 0.447 | [symbol] | 0.963 | 1.144 | 0.463 | 0.440 | [symbol] | 1.192 | 0.533 | 0.477 |
| ETTh2 | 96 | 0.269 | 0.720 | [symbol] | 0.332 | 0.645 | 1.549 | 0.274 | 0.277 | 0.347 | [symbol] | 0.381 | 0.291 |
| | 192 | 0.323 | 1.121 | 0.341 | 0.407 | [symbol] | 3.792 | 0.339 | 0.344 | 0.425 | 0.554 | 0.416 | 0.403 |
| | 336 | 0.317 | 1.524 | 0.329 | [symbol] | 0.907 | 4.215 | 0.361 | 0.357 | 0.414 | 0.582 | [symbol] | 0.466 |
| | 720 | 0.370 | 3.106 | 0.379 | 0.412 | 0.963 | 3.656 | 0.445 | 0.394 | 0.460 | 0.869 | 0.371 | 0.576 |
| ETTm1 | 96 | 0.282 | 0.336 | 0.293 | 0.326 | 0.543 | 0.626 | 0.285 | 0.306 | 0.322 | 0.406 | 0.343 | 0.311 |
| | 192 | 0.325 | 0.387 | 0.333 | 0.365 | 0.557 | 0.725 | 0.327 | 0.349 | 0.365 | 0.500 | 0.381 | 0.339 |
| | 336 | 0.352 | 0.431 | 0.369 | 0.392 | 0.754 | 1.005 | 0.356 | 0.375 | 0.392 | [symbol] | 0.436 | 0.366 |
| | 720 | 0.401 | 0.555 | 0.416 | 0.446 | 0.908 | 1.133 | 0.419 | 0.433 | 0.445 | 0.607 | 0.527 | 0.400 |
| ETTm2 | 96 | 0.160 | 0.338 | 0.166 | 0.180 | 0.435 | 0.355 | 0.163 | [symbol] | 0.191 | 0.238 | 0.218 | 0.165 |
| | 192 | 0.213 | 0.567 | 0.223 | 0.252 | 0.730 | 0.595 | [symbol] | 0.221 | 0.260 | 0.302 | 0.282 | 0.222 |
| | 336 | 0.262 | 1.050 | 0.274 | 0.324 | 1.201 | 1.270 | 0.268 | 0.274 | [symbol] | 0.447 | 0.378 | 0.278 |
| | 720 | 0.336 | 2.049 | 0.361 | 0.410 | 3.625 | 3.001 | 0.420 | 0.368 | 0.416 | 0.549 | 0.444 | 0.369 |
| Weather | 96 | 0.142 | 0.150 | 0.149 | 0.238 | 0.896 | 0.354 | 0.145 | 0.182 | 0.162 | [symbol] | 0.179 | 0.169 |
| | 192 | 0.185 | [symbol] | 0.194 | 0.275 | 0.622 | 0.419 | 0.191 | 0.225 | 0.213 | 0.231 | 0.230 | 0.211 |
| | 336 | 0.235 | [symbol] | 0.245 | 0.339 | 0.739 | [symbol] | 0.242 | 0.271 | 0.267 | [symbol] | 0.276 | 0.255 |
| | 720 | 0.305 | 0.310 | 0.314 | [symbol] | [symbol] | 0.916 | 0.320 | 0.335 | 0.343 | [symbol] | 0.347 | [symbol] |
| Elec- | 96 | 0.125 | 0.135 | 0.129 | 0.186 | 0.386 | 0.304 | 0.131 | 0.141 | OOM | 0.177 | 0.186 | 0.139 |
| tricity | 192 | 0.142 | 0.158 | 0.147 | 0.197 | 0.386 | 0.327 | 0.151 | 0.154 | OOM | 0.195 | 0.208 | 0.154 |
| | 336 | 0.154 | 0.177 | 0.163 | 0.213 | 0.378 | 0.333 | 0.161 | 0.171 | OOM | 0.213 | 0.210 | 0.169 |
| | 720 | 0.176 | 0.222 | 0.197 | 0.233 | 0.376 | 0.351 | 0.197 | 0.210 | OOM | 0.204 | 0.233 | 0.201 |
| Traffic | 96 | 0.345 | 0.481 | 0.360 | 0.576 | 2.085 | 0.733 | 0.376 | 0.410 | OOM | 0.489 | 0.599 | 0.401 |
| | 192 | 0.370 | 0.509 | 0.379 | [symbol] | 0.867 | 0.777 | 0.397 | 0.423 | OOM | 0.493 | 0.612 | 0.413 |
| | 336 | 0.385 | 0.534 | 0.392 | 0.608 | [symbol] | 0.776 | 0.413 | 0.435 | OOM | 0.496 | 0.618 | 0.425 |
| | 720 | 0.426 | 0.585 | 0.432 | 0.621 | 0.881 | 0.827 | 0.444 | 0.464 | OOM | 0.520 | 0.654 | 0.462 |

| | | | | | | | | | | | | |
|---|---|---|---|---|---|---|---|---|---|---|---|---|
| Avg. Rank | 1.036 | 7.214 | [symbol] | [symbol] | 10.286 | 10.429 | 2.786 | 4.607 | N/A | 8.000 | 7.25 | 4.357 |

[symbol]

indicates data missing or illegible when filed

Referring to [Table 2], it can be demonstrated that the ESSformer method achieves the most efficient computational complexity among various segment-based transformers. For example, [Table 2] illustrates that the ESSformer achieves the best performance in 27 out of 28 tasks of the M-LTSF. It is also illustrated that the second-best performance is achieved in the remaining one task. According to an embodiment of the invention, the ESSformer method may not only reduce computational complexity but also improve prediction performance.

An embodiment of the invention may also be implemented in the form of a recording medium including computer-executable instructions such as program modules executed by a computer. A computer-readable medium may be any available medium that can be accessed by the computer, and may include all of volatile and non-volatile media, and removable and non-removable media. In addition, the computer-readable medium may include both computer storage media and communication media. The computer storage media may include all of volatile and non-volatile, removable and non-removable media that are implemented in any method or technology for storage of information such as computer-readable instructions, data structures, program modules, or other data. The communication media typically include computer-readable instructions, data structures, or program modules and includes any information delivery media.

The above description of the invention is for illustrative purposes, and those skilled in the art to which the invention pertains will understand that various modifications can be easily made into other specific forms without departing from the technical spirit or essential characteristics of the present invention. Therefore, it should be understood that the above-described embodiments are illustrative and not restrictive in all respects. For example, each component described in a singular form may be implemented separately, and likewise, components described as being implemented separately may also be implemented in a combined form.

The scope of the invention is defined by the claims described below rather than the above detailed description, and all changes or modifications derived from the meaning and scope of the claims and their equivalent concepts should be construed as being included within the scope of the invention.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system comprising:
at least one processor;
an artificial intelligence prediction model; and
at least one memory storing one or more instructions that, when executed by the at least one processor, cause the at least one processor to perform operations comprising:
generating a plurality of observation data by sampling past data with an arbitrary time distribution;
generating a propagation signal associated with each of the plurality of observation data based on mean-field theory;
determining a predicted value by aggregating calculation results of the propagation signals associated with the plurality of observation data;
determining a loss value based on a difference between the predicted value and a true value; and
training the artificial intelligence prediction model until the loss value becomes less than or equal to a predetermined value.

2. The system of claim 1, wherein generating the propagation signal of each of the plurality of observation data comprises generating the propagation signal of each of the plurality of observation data by calculating a partial differential equation using gradient descent.

3. The system of claim 1, wherein generating the propagation signal associated with each of the plurality of observation data comprises:
generating a forward propagation signal; and
generating a backward propagation signal based on the forward propagation signal,
wherein performing operations by the at least one processor further comprises updating a control profile based on the backward propagation signal.

4. The system of claim 1, wherein generating the propagation signal associated with each of the plurality of observation data comprises generating a forward propagation signal and a backward propagation signal of each of the plurality of observation data using a neural graphon that is a symmetric integrable function.

5. The system of claim 4, wherein the neural graphon includes at least one of an exponential graphon and a cosinusoidal graphon.

6. The system of claim 1, wherein the artificial intelligence prediction model, after being trained until the loss value becomes less than or equal to the predetermined value, is used as a predictor for predicting future information.

7. The system of claim 1, wherein determining the predicted value by aggregating calculation results of the propagation signals associated with the plurality of observation data comprises determining an aggregation distribution using an attention mechanism.

8. A computer-implemented method, the method, when executed on data processing hardware, causing the data processing hardware to perform operations, the operations comprising:
generating a plurality of observation data by sampling past data with an arbitrary time distribution;
generating a propagation signal associated with each of the plurality of observation data based on mean-field theory;
determining a predicted value by aggregating a propagation signal calculation result associated with the plurality of observation data;
determining a loss value based on a difference between the predicted value and a true value; and
training an artificial intelligence prediction model until the loss value becomes less than or equal to a predetermined value.

9. The method of claim 8, wherein generating the propagation signal of each of the plurality of observation data comprises:
generating the propagation signal of each of the plurality of observation data by calculating a partial differential equation using gradient descent.

10. The system of claim 1, wherein generating the propagation signal associated with each of the plurality of observation data comprises:
generating a forward propagation signal; and
generating a backward propagation signal based on the forward propagation signal,
wherein the operations further comprise updating a control profile based on the backward propagation signal.

11. The method of claim 8, wherein generating the propagation signal associated with each of the plurality of observation data comprises:
generating a forward propagation signal and a backward propagation signal of each of the plurality of observation data using a neural graphon that is a symmetric integrable function.

12. The method of claim 11, wherein the neural graphon includes at least one of an exponential graphon and a cosinusoidal graphon.

13. The method of claim 8, wherein the artificial intelligence prediction model, after being trained until the loss value becomes less than or equal to the predetermined value, is used as a predictor for predicting future information.

14. The method of claim 8, wherein determining the predicted value by aggregating calculation results of the propagation signals associated with the plurality of observation data comprises determining an aggregation distribution using an attention mechanism.

15. A non-transitory computer-readable medium storing instructions that, when executed by a processor, cause the processor to perform the method of claim 8.

16. The non-transitory computer-readable medium of claim 15, wherein the instructions cause the processor to perform the method of claim 9.

17. The non-transitory computer-readable medium of claim 15, wherein the instructions cause the processor to perform the method of claim 10.

18. The non-transitory computer-readable medium of claim 15, wherein the instructions cause the processor to perform the method of claim 11.

19. The non-transitory computer-readable medium of claim 15, wherein the instructions cause the processor to perform the method of claim 13.

20. The non-transitory computer-readable medium of claim 15, wherein the instructions cause the processor to perform the method of claim 14.
